(19) United States
(12) Patent Application Publication
(10) Pub. No.: US 2022/0375136 A1
(43) Pub. Date: Nov. 24, 2022

(54) INFORMATION PROCESSING APPARATUS AND METHOD

(71) Applicant: SONY GROUP CORPORATION, TOKYO (JP)

(72) Inventors: TSUYOSHI KATO, TOKYO (JP); SATORU KUMA, KANAGAWA (JP); OHJI NAKAGAMI, TOKYO (JP); HIROYUKI YASUDA, TOKYO (JP); KOJI YANO, TOKYO (JP)

(21) Appl. No.: 17/755,377

(22) PCT Filed: Oct. 23, 2020
(86) PCT No.: PCT/JP2020/039842

§ 371 Date: Apr. 27, 2022

(30) Foreign Application Priority Data
Nov. 5, 2019 (JP) 2019-200679

(51) Int. Cl. G06T 9/00; G06T 9/40

(52) U.S. Cl. CPC G06T 9/001; G06T 9/40

(57) ABSTRACT

The present disclosure relates to an information processing apparatus and method for reducing a decrease in coding efficiency. The information processing apparatus encodes information regarding the luminance of a point corresponding to the lowest hierarchical level in hierarchized geometry data, and information regarding the color of a point corresponding to a predetermined hierarchical level higher than the lowest hierarchical level in the geometry data, in a point cloud expressing a three-dimensional object as a set of points. The present disclosure can be applied to an information processing apparatus, an image processing apparatus, an encoding device, a decoding device, an electronic apparatus, an information processing method, a program, or the like, for example.

### TECHNICAL FIELD

The present disclosure relates to an information processing apparatus and method, and more particularly, to an information processing apparatus and method designed to be capable of reducing a decrease in coding efficiency.

### BACKGROUND ART

Encoding and decoding of point cloud data expressing a three-dimensional object as a set of points has been standardized by Moving Picture Experts Group (MPEG) (see Non-Patent Document 1, for example). Point cloud data includes geometry data (positional information) and attribute data (attribute information) of points. This attribute data may include information regarding color (color and luminance) of points, such as RGB or YUV. Regarding decoding of this point cloud data, scalable decoding has also been suggested (see Non-Patent Document 2, for example).

### CITATION LIST

### Non-Patent Documents

Non-Patent Document 1: “Information technology—MPEG-I (Coded Representation of Immersive Media)—Part 9: Geometry-based Point Cloud Compression”, ISO/IEC 23090-9: 2019 (E)
Non-Patent Document 2: Ohji Nakagami, Satoru Kuma, “[G-PCC] Spatial scalability support for G-PCC”, ISO/IEC JTC1/SC29/WG11 MPEG2019/m47352, March 2019, Geneva, CH

### SUMMARY OF THE INVENTION

### Problems to be Solved by the Invention

However, by the method disclosed in Non-Patent Document 1, a color space to be applied to attribute data is only RGB or YUV 4:4:4. Therefore, color difference information cannot be decimated as in a format for two-dimensional images. As a result, the information amount becomes larger, and the coding efficiency might become lower.

The present disclosure is made in view of such circumstances, and aims to reduce the decrease in coding efficiency in encoding and decoding of a point cloud.

### Solutions to Problems

An information processing apparatus according to one aspect of the present technology is an information processing apparatus that includes an encoding unit that encodes information regarding the luminance of a point corresponding to the lowest hierarchical level in hierarchized geometry data, and information regarding the color of a point corresponding to a predetermined hierarchical level higher than the lowest hierarchical level in the geometry data, in a point cloud expressing a three-dimensional object as a set of points.

An information processing method according to one aspect of the present technology is an information processing method that includes encoding information regarding the luminance of a point corresponding to the lowest hierarchical level in hierarchized geometry data, and information regarding the color of a point corresponding to a predetermined hierarchical level higher than the lowest hierarchical level in the geometry data, in a point cloud expressing a three-dimensional object as a set of points.

An information processing apparatus according to another aspect of the present technology is an information processing apparatus that includes a decoding unit that decodes encoded data of a point cloud expressing a three-dimensional object as a set of points, and generates information regarding the luminance of a point corresponding to the lowest hierarchical level in hierarchized geometry data of the point cloud, and information regarding color of a point corresponding to a predetermined hierarchical level higher than the lowest hierarchical level in the geometry data.

An information processing method according to another aspect of the present technology is an information processing method that includes decoding encoded data of a point cloud expressing a three-dimensional object as a set of points, and generates information regarding the luminance of a point corresponding to the lowest hierarchical level in hierarchized geometry data of the point cloud, and information regarding color of a point corresponding to a predetermined hierarchical level higher than the lowest hierarchical level in the geometry data.

In the information processing apparatus and method according to one aspect of the present technology, encoding is performed on information regarding the luminance of a point corresponding to the lowest hierarchical level in hierarchized geometry data, and information regarding the color of a point corresponding to a predetermined hierarchical level higher than the lowest hierarchical level in the geometry data in a point cloud expressing a three-dimensional object as a set of points.

In the information processing apparatus and method according to another aspect of the present technology, decoding is performed on encoded data of a point cloud expressing a three-dimensional object as a set of points, to generate information regarding the luminance of a point corresponding to the lowest hierarchical level in the hierarchized geometry data of the point cloud and information regarding the color of a point corresponding to a predetermined hierarchical level higher than the lowest hierarchical level in the geometry data.

### BRIEF DESCRIPTION OF DRAWINGS

FIG. 1 is a diagram for explaining a state of YUV 4:2:0 of a two-dimensional image.

FIG. 2 is a diagram for explaining an example of decimation of color information in a point cloud.

FIG. 3 is a diagram for explaining encoding.

FIG. 4 is a diagram for explaining an example of a downsampling method.

FIG. 5 is a diagram for explaining upsampling.

FIG. 6 is a diagram for explaining an example configuration of a bitstream.

FIG. 7 is a diagram for explaining an example of a Ply format.

FIG. 8 is a diagram for explaining an example of a Ply format.

FIG. 9 is a block diagram showing a typical example configuration of an encoding device.

FIG. 10 is a block diagram showing a typical example configuration of an attribute information encoding unit.

FIG. 11 is a table for explaining the features of each processing unit.

FIG. 12 is a flowchart for explaining an example flow in an encoding process.

FIG. 13 is a flowchart for explaining an example flow in an attribute information encoding process.

FIG. 14 is a block diagram showing a typical example configuration of a decoding device.

FIG. 15 is a block diagram showing a typical example configuration of an attribute information decoding unit.

FIG. 16 is a table for explaining the features of each processing unit.

FIG. 17 is a flowchart for explaining an example flow in a decoding process.

FIG. 18 is a flowchart for explaining an example flow in an attribute information decoding process.

FIG. 19 is a block diagram showing a typical example configuration of an encoding device.

FIG. 20 is a block diagram showing a typical example configuration of an attribute information encoding unit.

FIG. 21 is a flowchart for explaining an example flow in an encoding process.

FIG. 22 is a flowchart for explaining an example flow in an attribute information encoding process.

FIG. 23 is a block diagram showing a typical example configuration of an attribute information encoding unit.

FIG. 24 is a flowchart for explaining an example flow in an attribute information encoding process.

FIG. 25 is a block diagram showing a typical example configuration of an attribute information decoding unit.

FIG. 26 is a flowchart for explaining an example flow in an attribute information decoding process.

FIG. 27 is a block diagram showing a typical example configuration of a computer.

### MODE FOR CARRYING OUT THE INVENTION

The following is a description of modes for carrying out the present disclosure (the modes will be hereinafter referred to as embodiments). Note that explanation will be made in the following order.

1. Color space extension in a point cloud

2. First embodiment (an encoding device)

3. Second embodiment (a decoding device)

4. Third embodiment (compatible with scalable decoding 1)

5. Fourth embodiment (compatible with scalable decoding 2)

6. Notes

<1. Color Space Extension in a Point Cloud>

<Documents and the Like that Support Technical Contents and Terms>

The scope disclosed in the present technology includes not only the contents disclosed in the embodiments, but also the contents disclosed in the following non-patent documents that were known at the time of filing, the contents of other documents referred to in the non-patent documents listed below, and the like.
Non-Patent Document 1: (mentioned above)
Non-Patent Document 2: (mentioned above)

That is, the contents described in the above non-patent documents, the contents of other documents referred to in the above non-patent documents, and the like are also grounds for determining the support requirements.

<Point Cloud>

There has been 3D data such as point clouds that represent three-dimensional structures with positional information, attribute information, and the like about points, and meshes that are formed with vertices, edges, and planes, and define three-dimensional shapes using polygonal representations.

For example, in the case of a point cloud, a three-dimensional structure (a three-dimensional object) is expressed as a set of a large number of points. The data of a point cloud (also referred to as point cloud data) includes positional information (also referred to as geometry data) and attribute information (also referred to as attribute data) about the respective points in this point cloud. The attribute data can include any information. For example, information about color and luminance, reflectance information, normal information, and the like regarding the respective points may be included in the attribute data. As described above, the data structure of point cloud data is relatively simple, and any desired three-dimensional structure can be expressed with a sufficiently high accuracy with the use of a sufficiently large number of points.

<Quantization of Positional Information Using Voxels>

Since the data amount of such point cloud data is relatively large, an encoding method using voxels has been suggested to reduce the data amount by encoding and the like. A voxel is a three-dimensional region for quantizing geometry data (positional information).

That is, a three-dimensional region containing a point cloud is divided into small three-dimensional regions called voxels, and each voxel indicates whether or not points are contained therein. With this arrangement, the position of each point is quantized in voxel units. Accordingly, point cloud data is transformed into such data of voxels (also referred to as voxel data), so that an increase in the amount of information can be prevented (typically, the amount of information can be reduced).

<Octree>

Further, as for geometry data, construction of an octree using such voxel data has been suggested. An octree is a tree-structured version of voxel data. The value of each bit of the lowest nodes of this octree indicates the presence or absence of points in each voxel. For example, a value “1” indicates a voxel containing points, and a value “0” indicates a voxel containing no points. In the octree, one node corresponds to eight voxels. That is, each node of the octree is formed with 8-bit data, and the eight bits indicate the presence or absence of points in eight voxels.

Further, a higher node of the octree indicates the presence or absence of points in a region in which the eight voxels corresponding to the lower node belonging to the node are combined into one. That is, the higher node is generated by gathering the voxel information about the lower node. Note that, when the value of a node is “0”, or when all the eight corresponding voxels contain no points, the node is deleted.

In this manner, a tree structure (an octree) formed with nodes whose values are not “0” is constructed. That is, an octree can indicate the presence or absence of points in voxels at each resolution. Having been turned into an octree and been encoded, the positional information is decoded from the highest resolution (the highest hierarchical level) to a desired hierarchical level (resolution). Thus, the point cloud data with that resolution can be restored. That is, decoding can be easily performed with a desired resolution, without decoding of information at unnecessary hierarchical levels (resolutions). In other words, voxel (resolution) scalability can be achieved.

Furthermore, as the nodes having the value “0” are eliminated as described above, the voxels in the regions without points can be lowered in resolution. Thus, an increase in the amount of information can be further prevented (typically, the amount of information can be reduced).

<Attribute Data>

As a method for encoding such attribute data, a method or the like using region adaptive hierarchical transform (RAHT) or transform called “lifting” has been conceived, for example. By adopting these techniques, it is possible to hierarchize attribute data like an octree of geometry data.

<Encoding of a Point Cloud>

As of September 2019, standardization of point cloud data encoding and decoding is in progress by Moving Picture Experts Group (MPEG). Before that, as described in Non-Patent Document 1, techniques using voxels and octrees like those described above have been suggested, for example.

<Color Space>

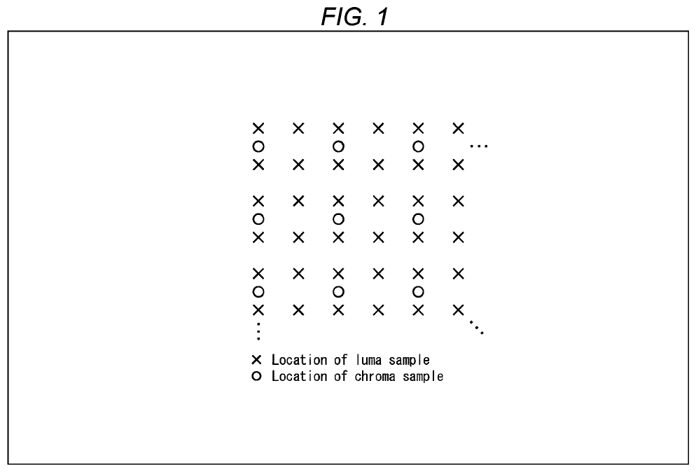

Meanwhile, in the case of encoding of a two-dimensional image, it is normally possible to use a color space such as YUV 4:2:0 for decimating color difference information using characteristics of the human eye, as shown in FIG. 1. However, as disclosed in Non-Patent Document 1, a color space to be applied to point cloud data (attribute data) is only RGB or YUV 4:4:4. Therefore, color difference information cannot be decimated as in YUV 4:2:0 of a two-dimensional image. As a result, the information amount becomes larger, and the coding efficiency might become lower.

<Reduction of Information Regarding Color>

Note that a color space of YUV (YCbCr) is applied to attribute data, and attribute data includes information regarding luminance (Luma) and information regarding color (Chroma) of points. This information regarding color may also include information regarding color difference.

In this point cloud data (attribute data), the number of pieces of information regarding color is also to be reduced. More specifically, the information regarding color is associated with a higher hierarchical level than the hierarchical level to which the information regarding luminance corresponds in the geometry data.

As described above, geometry data is hierarchized and encoded, with the use of an octree or the like. The attribute data normally corresponds to the lowest hierarchical level in this geometry data (which is the geometry data of the highest resolution). In other words, the information regarding luminance and the information regarding color hold information about points corresponding to the geometry data at this lowest hierarchical level.

In general, in the hierarchical structure of geometry data, the number of nodes is smaller (or the number of points is smaller) at a higher hierarchical level. Accordingly, the information regarding color is associated with geometry data at a higher hierarchical level, so that the number of pieces of the information regarding color decreases. That is, the information regarding color is designed to hold information about a point corresponding to the geometry data at a higher hierarchical level (with a lower resolution).

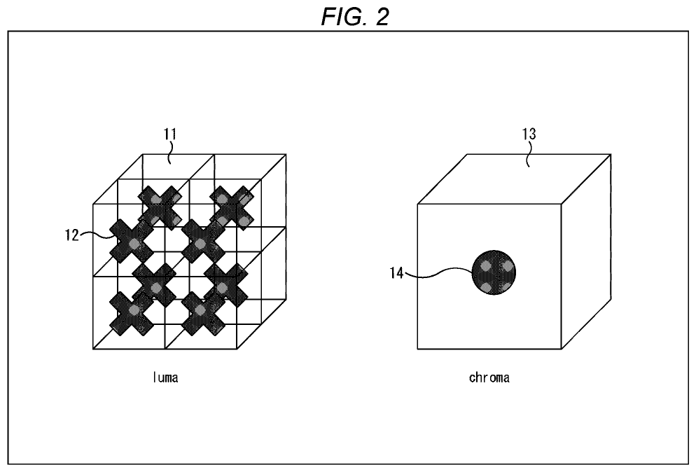

For example, as shown in FIG. 2, encoding is performed on information 12 regarding the luminance of the respective points corresponding to respective voxels 11, and information 14 regarding the color of a point corresponding to a voxel 13 that is one level higher than the voxels 11.

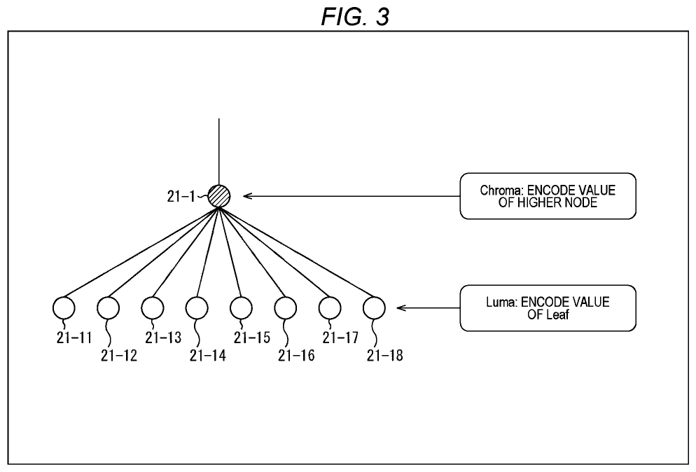

Alternatively, as shown in FIG. 3, encoding is performed on information regarding the luminance of the respective points corresponding to leaf nodes 21-11 to 21-18 of an octree, and information regarding the color of a point corresponding to a node 21-1 that is the parent node of the leaf nodes 21-11 to 21-18, for example.

As the information regarding color is associated with the hierarchical level that is one level higher than the hierarchical level to which the information regarding luminance corresponds in the geometry data as described above, the number of pieces of information regarding color can be made smaller than the number of pieces of information regarding luminance. For example, the ratio between the number of pieces of information regarding luminance and the number of pieces of information regarding color can be 8:1. This color space is also called YUV 8:1:1.

Note that the hierarchical level to which the information regarding color corresponds may be any hierarchical level that is higher than the hierarchical level to which the information regarding luminance corresponds. For example, the hierarchical level to which the information regarding color corresponds may be a hierarchical level that is two or more levels higher than the hierarchical level to which the information regarding luminance corresponds.

That is, the encoding side is designed to be able to encode the information regarding the luminance of points corresponding to the lowest hierarchical level in the hierarchized geometry data, and the information regarding the color of a point corresponding to a predetermined hierarchical level higher than the lowest hierarchical level in the geometry data in a point cloud expressing a three-dimensional object as a set of points, for example.

Further, an information processing apparatus, for example, is designed to include an encoding unit that encodes the information regarding the luminance of points corresponding to the lowest hierarchical level in the hierarchized geometry data, and the information regarding the color of a point corresponding to a predetermined hierarchical level higher than the lowest hierarchical level in the geometry data in a point cloud expressing a three-dimensional object as a set of points.

With such arrangement, the number of pieces of information regarding color can be made smaller than the number of pieces of information regarding luminance, and thus, the decrease in coding efficiency can be reduced. Typically, coding efficiency can be increased.

Also, the decoding side is designed to decode encoded data of a point cloud expressing a three-dimensional object as a set of points, for example, and generate information regarding the luminance of points corresponding to the lowest hierarchical level in the hierarchized geometry data of the point cloud and information regarding the color of a point corresponding to a predetermined hierarchical level higher than the lowest hierarchical level in the geometry data.

Further, an information processing apparatus, for example, is designed to include a decoding unit that decodes encoded data of a point cloud expressing a three-dimensional object as a set of points, and generates information regarding the luminance of points corresponding to the lowest hierarchical level in the hierarchized geometry data of the point cloud and information regarding the color of a point corresponding to a predetermined hierarchical level higher than the lowest hierarchical level in the geometry data.

With such arrangement, information regarding luminance and information regarding color that differ in the number of pieces from each other can be correctly decoded. Thus, the decrease in coding efficiency can be reduced. Typically, coding efficiency can be increased.

Note that the predetermined hierarchical level mentioned above may be the hierarchical level that is one level higher than the lowest hierarchical level. The information regarding color is associated with the hierarchical level that is one level higher than the lowest hierarchical level in the octree, so that YUV 8:1:1 is obtained.

<Downsampling>

The information regarding color corresponding to a predetermined hierarchical level in geometry data can be generated by any appropriate method. For example, downsampling may be performed on the information regarding color, to generate the information regarding color corresponding to a predetermined hierarchical level in the geometry data.

The downsampling method herein may be any appropriate method. For example, the information regarding the color of points corresponding to the lowest hierarchical level in the geometry data may be used to derive the information regarding the color of a point corresponding to a predetermined hierarchical level in the geometry data.

For example, the information regarding the color of the points corresponding to the lowest hierarchical level in geometry data located in a voxel corresponding to a predetermined hierarchical level in the geometry data may be averaged so that the information regarding the color of points corresponding to the voxel is derived.

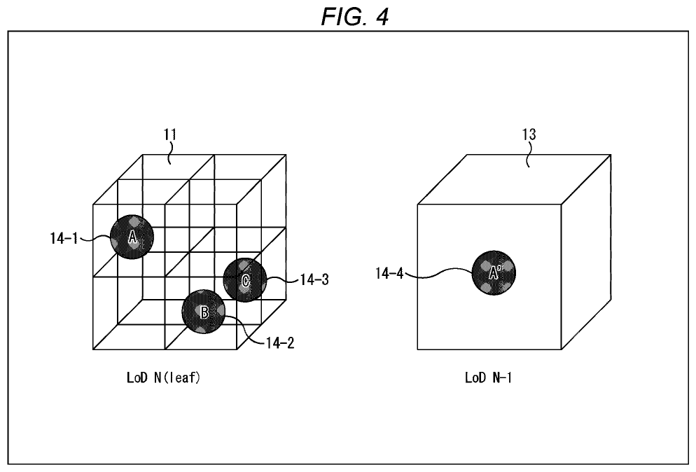

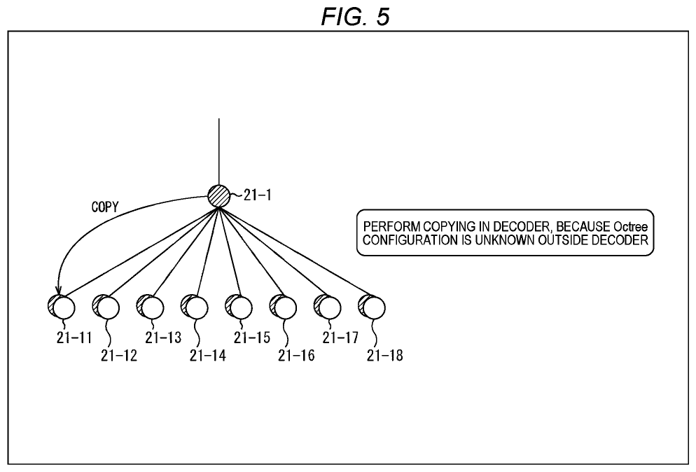

For example, as shown at the left side in FIG. 4, the value of information 12-1 regarding the color of a point corresponding to a voxel 11 at the lowest hierarchical level (LoD N (Leaf)) is “A”, the value of information 12-2 regarding the color of a point corresponding to the voxel 11 is “B”, and the value of information 12-3 regarding the color of a point corresponding to the voxel 11 is “C”. In this case, the value “A′” of information 14 regarding the color of a point corresponding to a voxel 13 that is one level higher than the voxel 11 may be derived as in Expression (1) shown below.

A′=(A+B+C)/3 (1)

The derivation function for the information regarding color may of course be any appropriate function, and is not limited to Expression (1). For example, weighting may be performed in accordance with the distance between each two values among the values A to C.

Also, a recoloring process for associating information regarding the color of a point with geometry data may be performed, for example, to derive information regarding the color of a point corresponding to a predetermined hierarchical level in the geometry data.

<Method Using Hierarchization>

Note that, instead of downsampling, the hierarchical structure of attribute data is used, to derive information regarding the color of a point corresponding to a predetermined hierarchical level in geometry data. For example, when encoding is performed so that scalable decoding can be performed, the attribute data is hierarchized so as to have a hierarchical structure similar to that of the geometry data. Accordingly, in this case, the attribute data (the information regarding color) at a predetermined hierarchical level corresponds to the predetermined hierarchical level in the geometry data.

<Upsampling>

At the time of decoding, upsampling may be performed on the information regarding the color of a point corresponding to a predetermined hierarchical level in the geometry data restored from encoded data. In this manner, information regarding the color corresponding to the lowest hierarchical level in the geometry data may be generated.

The upsampling method herein may be any appropriate method. For example, the information regarding the color of a point corresponding to a predetermined hierarchical level in the geometry data may be used to derive the information regarding the color of points corresponding to the lowest hierarchical level in the geometry data.

For example, the information regarding the color of a point corresponding to a predetermined hierarchical level in the geometry data may be duplicated to derive the information regarding the color of points corresponding to the lowest hierarchical level in the geometry data.

For example, when encoded data generated as in the example shown in FIG. 3 is to be decoded, the information regarding the color of the point corresponding to the node 21-1 is decoded. After that, the information regarding the color of the point corresponding to the node 21-1 may be duplicated, to derive the information regarding the color of the point corresponding to each of the leaf nodes 21-11 to 21-18, which are one hierarchical level lower than the node 21-1.

Also, a recoloring process for associating information regarding the color of a point with geometry data may be performed, for example, to derive information regarding the color of points corresponding to the lowest hierarchical level in the geometry data.

<Predetermined Hierarchical Level>

In the description below, the resolution of the hierarchical level (or a predetermined hierarchical level) in the geometry data to which the information regarding color to be encoded corresponds will be also referred to as the sampling resolution. Also, in the description below, the information regarding luminance to be encoded corresponds to the lowest hierarchical level in the geometry data, and the information regarding color to be encoded corresponds to a hierarchical level that is one level higher than the lowest hierarchical level in the geometry data, unless otherwise specified. That is, the sampling resolution is a resolution coarser than the highest resolution by one hierarchical level. Further, YUV (YCbCr) 8:1:1 is adopted as the color space.

<Configuration of a Bitstream>

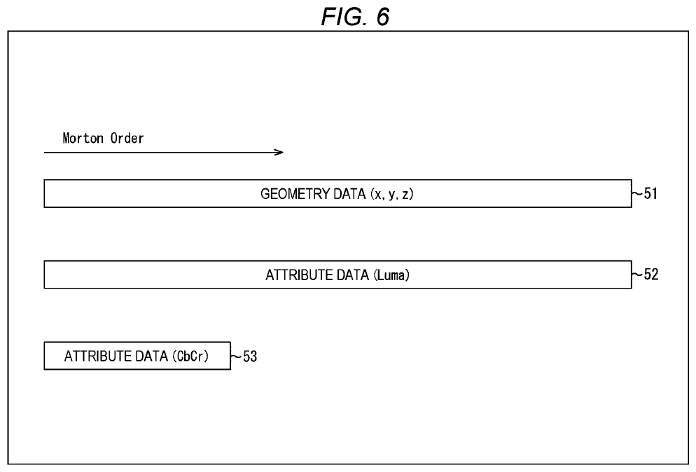

Note that a bitstream that is generated as above, and includes encoded data of geometry data, encoded data of information regarding luminance, and encoded data of information regarding color may be designed as in an example shown in FIG. 6. That is, as shown in FIG. 6, this bitstream 50 includes encoded data 51 of geometry data, encoded data 52 of information regarding luminance (attribute data (Luma)), and encoded data 53 of information regarding color (attribute data (CbCr)).

The encoded data 52 of the information regarding luminance includes data equivalent to the number of points corresponding to the lowest hierarchical level in the geometry data, and the encoded data 53 of the information regarding color includes data equivalent to the number of points corresponding to a predetermined hierarchical level in the geometry data.

Further, among the encoded data 51 of the geometry data, the encoded data 52 of the information regarding luminance, and the encoded data 53 of the information regarding color, information regarding the respective points may be aligned in the same predetermined order.

For example, among the encoded data 51 of the geometry data, the encoded data 52 of the information regarding luminance, and the encoded data 53 of the information regarding color, the information regarding the respective points may be aligned in the Morton order.

<Point Cloud Data>

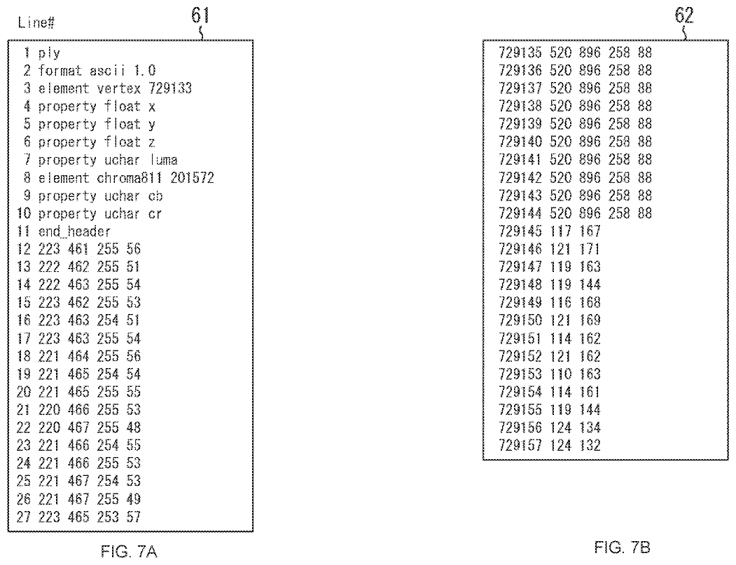

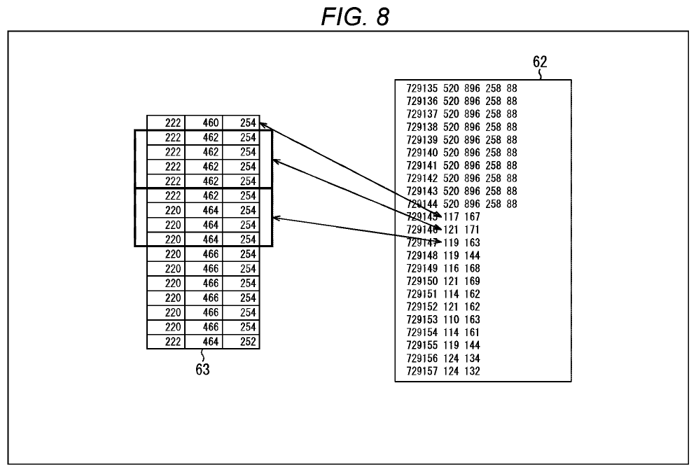

FIGS. 7 and 8 show examples of point cloud data using a polygon file format (Ply file format). Data 61 shown in A of FIG. 7 and data 62 in B of FIG. 7 indicate portions of point cloud data in the Ply file format that are different from each other.

As shown in the data 61 in A of FIG. 7, the third to seventh lines in this case indicate that there exist 729133 pieces of data arranged in “x y z luma”, or data arranged in the order of “the x-coordinate of the point, the y-coordinate of the point, the z-coordinate of the point, and the luminance value of the point”, in the point cloud data. Further, data arranged in “x y z luma” is stored in the 12th to 721944th lines. This data indicates the positions and the luminance values of the respective points.

Furthermore, the eighth to tenth lines indicate that there exist 201572 pieces of data arranged in “Cb Cr”, which is data arranged in the order of “the color (Cb) of the point, and the color (Cr) of the point”, in the point cloud data. Further, data arranged in “Cb Cr” is stored in the 729145th and later lines. This data indicates the color values (Cb) and the color values (Cr) of the respective points.

In such point cloud data, grouping is performed on the coordinate information about the respective points at a hierarchical level that is one level higher (which is with a resolution that is coarser by one hierarchical level), as in data 63 shown in FIG. 8, for example. The color (Cb) and the color (Cr) are then associated with each group, as indicated by double-headed arrows in FIG. 8. Downsampling may be performed in such a manner.

### 2. First Embodiment

<Encoding Device>

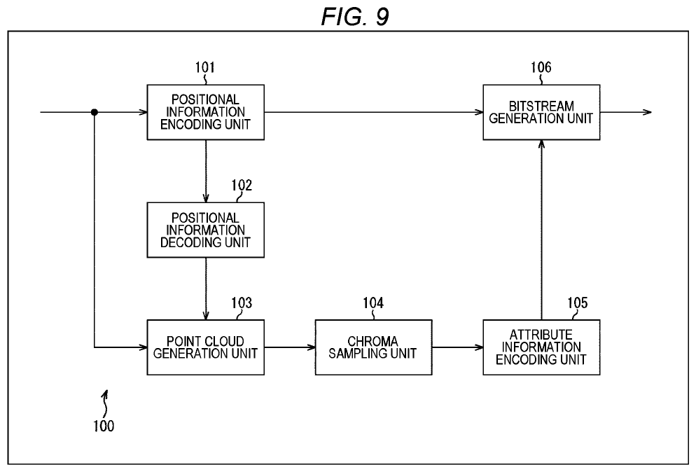

FIG. 9 is a block diagram showing an example configuration of an encoding device as an embodiment of an information processing apparatus to which the present technology is applied. An encoding device 100 shown in FIG. 9 is a device that encodes 3D data such as a point cloud. In this encoding, the encoding device 100 hierarchizes and encodes point cloud data using voxels, an octree, or the like, for example. At that time, the encoding device 100 can use YUV 8:1:1 as the color space by appropriately adopting the various methods described above in <1. Color Space Extension in a Point Cloud>.

Meanwhile, there is a method for decoding encoded data of point cloud data hierarchized with the use of voxels, an octree, or the like at an appropriate resolution (like the scalable decoding disclosed in Non-Patent Document 2). For example, in this case of scalable decoding, encoded data of a higher hierarchical level than the desired hierarchical level is decoded, so that point cloud data of the desired hierarchical level can be generated. That is, when a point cloud with an intermediate resolution that is lower than the highest resolution (or a point cloud corresponding to a higher hierarchical level than the lowest hierarchical level in the hierarchical structure) is to be obtained, there is no need to decode the encoded data of all the hierarchical levels (it is only required to decode the encoded data of some hierarchical levels).

The encoding device 100 in the case of this embodiment encodes point cloud data by a method that is not necessarily capable of such scalable decoding (a method that is not compatible with scalable decoding).

Note that FIG. 9 shows the principal components and aspects such as processing units and a data flow, but FIG. 9 does not necessarily show all the components and aspects. That is, in the encoding device 100, there may be a processing unit that is not shown as a block in FIG. 9, or there may be a process or data flow that is not shown as an arrow or the like in FIG. 9. This also applies to the other drawings for explaining the processing units and the like in the encoding device 100.

As shown in FIG. 9, the encoding device 100 includes a positional information encoding unit 101, a positional information decoding unit 102, a point cloud generation unit 103, a chroma sampling unit 104, an attribute information encoding unit 105, and a bitstream generation unit 305.

The positional information encoding unit 101 performs a process related to encoding of geometry data (positional information). For example, the positional information encoding unit 101 can acquire point cloud data that has been input to the encoding device 100. The positional information encoding unit 101 can also perform hierarchization and lossless encoding on the geometry data of the point cloud data, to generate encoded data. Further, the positional information encoding unit 101 can supply the generated encoded data of the geometry data to the positional information decoding unit 102 and the bitstream generation unit 106.

Note that any appropriate method may be used as the method for the geometry data hierarchization and lossless encoding to be performed by the positional information encoding unit 101. For example, the positional information encoding unit 101 may hierarchize the geometry data, using voxels or an octree. Also, the positional information encoding unit 101 may encode the hierarchized geometry data by Context-based Adaptive Binary Arithmetic Code (CABAC). Further, processing such as filtering for noise reduction (denoising) and quantization may be performed, for example.

The positional information decoding unit 102 performs a process related to decoding of the encoded data of the geometry data. For example, the positional information decoding unit 102 can acquire the encoded data of the geometry data supplied from the positional information encoding unit 101. The positional information decoding unit 102 can also perform lossless decoding and inverse hierarchization on the encoded data, to generate (restore) geometry data. Further, the positional information decoding unit 102 can supply the generated (restored) geometry data (the decoding result) to the point cloud generation unit 103.

Note that the method for the inverse hierarchization and the lossless decoding to be performed by the positional information decoding unit 102 on the encoded data of the geometry data may be any appropriate method compatible with the method for the hierarchization and the lossless encoding performed by the positional information encoding unit 101. For example, processing such as filtering for denoising and inverse quantization may be performed.

The point cloud generation unit 103 performs a process related to generation of a point cloud. For example, the point cloud generation unit 103 can acquire the point cloud data that is input to the encoding device 100. The point cloud generation unit 103 can also acquire the geometry data (the decoding result) supplied from the positional information decoding unit 102. Further, the point cloud generation unit 103 can perform a process (a recoloring process) of matching the attribute data of the acquired point cloud data with the acquired geometry data (the decoding result). Furthermore, the point cloud generation unit 103 can supply the generated point cloud data (which is the geometry data (the decoding result) and attribute data corresponding to the geometry data) to the chroma sampling unit 104.

The chroma sampling unit 104 performs a process related to downsampling of information regarding color. For example, the chroma sampling unit 104 can acquire the point cloud data supplied from the point cloud generation unit 103. The chroma sampling unit 104 can also downsample the information regarding the color of the point cloud data, to associate the data with the level that is one hierarchical level higher than the lowest hierarchical level in the geometry data. The chroma sampling unit 104 can supply the attribute information encoding unit 105 with the point cloud data obtained by downsampling the information regarding color in this manner.

Note that, in this downsampling, the chroma sampling unit 104 can appropriately adopt each method explained above in <Downsampling>. For example, the chroma sampling unit 104 can downsample the information regarding the color of a point, to generate information regarding the color of a point corresponding to a predetermined hierarchical level in the geometry data.

In this manner, the chroma sampling unit 104 downsamples the information regarding color. Therefore, in the point cloud data supplied to the attribute information encoding unit 105, the number of pieces of information regarding luminance and the number of pieces of information regarding color differ from each other. More specifically, the number of points corresponding to the information regarding color is smaller than the number of points corresponding to the information regarding luminance. More specifically, the number of pieces of information regarding luminance corresponds to the number of leaf nodes in the hierarchical structure of the geometry data, which is the number of points with the highest resolution. On the other hand, the number of pieces of information regarding color corresponds to the number of nodes at the level that is one hierarchical level higher than the lowest hierarchical level in the hierarchical structure of the geometry data, which is the number of points with resolution that is lower than the highest resolution by one hierarchical level.

The attribute information encoding unit 105 performs a process related to encoding of attribute data. For example, the attribute information encoding unit 105 can acquire the point cloud data supplied from the point cloud generation unit 103. The attribute information encoding unit 105 can also perform hierarchization and lossless encoding on the attribute data of the point cloud data by a method incompatible with scalable decoding, to generate encoded data of the attribute data. Further, the attribute information encoding unit 105 can supply the generated encoded data of the attribute data to the bitstream generation unit 106.

In doing so, the attribute information encoding unit 105 can encode the attribute data by appropriately adopting each method described above in <1. Color Space Extension in a Point Cloud> and adopting YUV (YCbCr) 8:1:1.

Note that, as described above, the information regarding the luminance and the information regarding the color of the attribute data to be decoded differ from each other in the number of pieces of information. Therefore, the attribute information encoding unit 105 performs lossless encoding after hierarchizing both the information regarding luminance and the information regarding color.

The hierarchization method at that time may be any appropriate method that is not compatible with scalable decoding. For example, the attribute information encoding unit 105 may hierarchize the information regarding luminance and the information regarding color, using RAHT, Lifting, or the like. Also, the attribute information encoding unit 105 may encode the hierarchized information regarding luminance and the hierarchized information regarding color by CABAC. Further, processing such as filtering for noise reduction (denoising) and quantization may be performed, for example.

The bitstream generation unit 106 performs a process related to generation of a bitstream. For example, the bitstream generation unit 106 can acquire the encoded data of the geometry data supplied from the positional information encoding unit 101. The bitstream generation unit 106 can also acquire the encoded data of the attribute data supplied from the attribute information encoding unit 105. Further, the bitstream generation unit 106 can generate a bitstream including these sets of encoded data. The bitstream generation unit 106 can also output the generated bitstream to the outside of the encoding device 100.

For example, the bitstream generation unit 106 can generate a bitstream having a configuration as described above in <Configuration of a Bitstream>.

With such a configuration, the encoding device 100 can perform encoding with the number of pieces of information regarding color being smaller than the number of pieces of information regarding luminance, and thus, can reduce the decrease in coding efficiency. Typically, coding efficiency can be increased.

Note that each of these processing units (from the positional information encoding unit 101 to the bitstream generation unit 106) of the encoding device 100 has any appropriate configuration. For example, each processing unit may be formed with a logic circuit that performs the processes described above. Alternatively, each processing unit may include a central processing unit (CPU), a read only memory (ROM), a random access memory (RAM), and the like, for example, and execute a program using these components, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Attribute Information Encoding Unit>

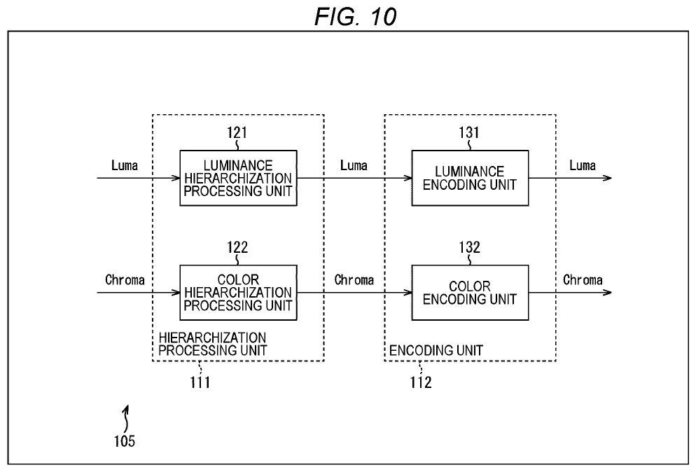

FIG. 10 is a block diagram showing a typical example configuration of the attribute information encoding unit 105 (FIG. 9). As shown in FIG. 10, the attribute information encoding unit 105 includes a hierarchization processing unit 111 and an encoding unit 112.

The hierarchization processing unit 111 performs a process related to hierarchization of attribute data. For example, the hierarchization processing unit 111 can acquire the point cloud data (attribute data and geometry data (a decoding result)) supplied from the chroma sampling unit 104. Using the geometry data, the hierarchization processing unit 111 can also hierarchize the attribute data by a method that is not compatible with scalable decoding. Further, the hierarchization processing unit 111 can supply the hierarchized attribute data to the encoding unit 112.

In this hierarchization, the hierarchization processing unit 111 hierarchizes the information regarding luminance and the information regarding color included in the attribute data through separate processes, as described above.

For example, as shown in FIG. 10, the hierarchization processing unit 111 includes a luminance hierarchization processing unit 121 and a color hierarchization processing unit 122.

The luminance hierarchization processing unit 121 performs a process related to hierarchization of information regarding luminance. For example, the luminance hierarchization processing unit 121 can acquire the information regarding luminance (Luma) included in the hierarchized attribute data supplied from the hierarchization processing unit 111. The luminance hierarchization processing unit 121 can also hierarchize the information regarding luminance. Further, the luminance hierarchization processing unit 121 can supply the hierarchized information regarding luminance to (the luminance encoding unit 131 of) the encoding unit 112.

The method for this hierarchization of the information regarding luminance may be any appropriate method. For example, the luminance hierarchization processing unit 121 may hierarchize the information regarding luminance by RAHT, Lifting, or the like, using the geometry data (decoding result).

The color hierarchization processing unit 122 performs a process related to hierarchization of information regarding color. For example, the color hierarchization processing unit 122 acquires the information regarding color (Chroma) included in the hierarchized attribute data supplied from the hierarchization processing unit 111. The color hierarchization processing unit 122 can hierarchize the information regarding color. Further, the color hierarchization processing unit 122 can supply the hierarchized information regarding color to (the color encoding unit 132 of) the encoding unit 112.

The method for this hierarchization of the information regarding color may be any appropriate method. For example, the color hierarchization processing unit 122 may hierarchize the information regarding color by RAHT, Lifting, or the like, using the geometry data (decoding result).

With such a configuration, the hierarchization processing unit 111 can hierarchize both the information regarding luminance and the information regarding color through separate processes. Accordingly, the hierarchization processing unit 111 can hierarchize the information regarding luminance and the information regarding color, which differ from each other in the number of pieces of information.

In addition to that, as the hierarchization processing unit 111 performs hierarchization in such a manner, the information regarding luminance and the information regarding color are hierarchized to have different hierarchical structures from each other. That is, the hierarchized information about luminance and the hierarchized information about color have different hierarchical structures from each other. Therefore, both sets of information are not compatible with scalable decoding.

The encoding unit 112 performs a process related to encoding of attribute data. For example, the encoding unit 112 can acquire the hierarchized attribute data supplied from the hierarchization processing unit 111. The encoding unit 112 can also perform lossless encoding on the attribute data, and generate encoded data of the attribute data. Further, the encoding unit 112 can supply the generated encoded data of the attribute data to the bitstream generation unit 106.

In the meantime, for the lossless encoding of the attribute data, two kinds of lossless encoding can be adopted: three-channel lossless encoding for performing a process by handling three channels (3ch) at the same time (for enhancing coding efficiency in a plurality of contexts), and one-channel lossless encoding for processing one channel (1ch) at a time. As described above, the information regarding luminance and the information regarding color supplied from the hierarchization processing unit 111 have different hierarchical structures from each other. Therefore, the encoding unit 112 performs lossless encoding on the information regarding luminance and the information regarding color, without interleaving. Therefore, the encoding unit 112 in this case adopts one-channel lossless encoding, and performs lossless encoding on both the information regarding luminance and the information regarding color, without interleaving.

That is, the encoding unit 112 encodes the information regarding the luminance of points corresponding to the lowest hierarchical level in the hierarchized geometry data of the point cloud, and the information regarding the color of a point corresponding to a predetermined hierarchical level higher than the lowest hierarchical level in the geometry data.

For example, as shown in FIG. 10, the encoding unit 112 includes a luminance encoding unit 131 and a color encoding unit 132.

The luminance encoding unit 131 performs a process related to one-channel lossless encoding of information regarding luminance. For example, the luminance encoding unit 131 can acquire the hierarchized information regarding luminance supplied from the luminance hierarchization processing unit 121. The luminance encoding unit 131 can also perform lossless encoding on the information regarding luminance, to generate encoded data of the information regarding luminance. Further, the luminance encoding unit 131 can supply the generated encoded data of the information regarding luminance to the bitstream generation unit 106.

The color encoding unit 132 performs a process related to one-channel lossless encoding of information regarding color. For example, the color encoding unit 132 can acquire the hierarchized information regarding color supplied from the color hierarchization processing unit 122. The color encoding unit 132 can also perform lossless encoding on the information regarding color, to generate encoded data of the information regarding color. Further, the color encoding unit 132 can supply the generated encoded data of the information regarding color to the bitstream generation unit 106.

These encoding methods may be any appropriate methods, and may be CABAC, for example.

With such a configuration, the encoding unit 112 can adopt one-channel lossless encoding, and perform lossless encoding on both the information regarding luminance and the information regarding color, without interleaving. Thus, the encoding unit 112 can perform lossless encoding on the information regarding luminance and the information regarding color hierarchized in different hierarchical structures, and generate both encoded data of the information regarding luminance and encoded data of the information regarding color.

Accordingly, the encoding device 100 can perform encoding with the number of pieces of information regarding color being smaller than the number of pieces of information regarding luminance, and thus, can reduce the decrease in coding efficiency. Typically, coding efficiency can be increased.

Note that these processing units (the hierarchization processing unit 111 and the encoding unit 112) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Explanation of Each Processing Unit>

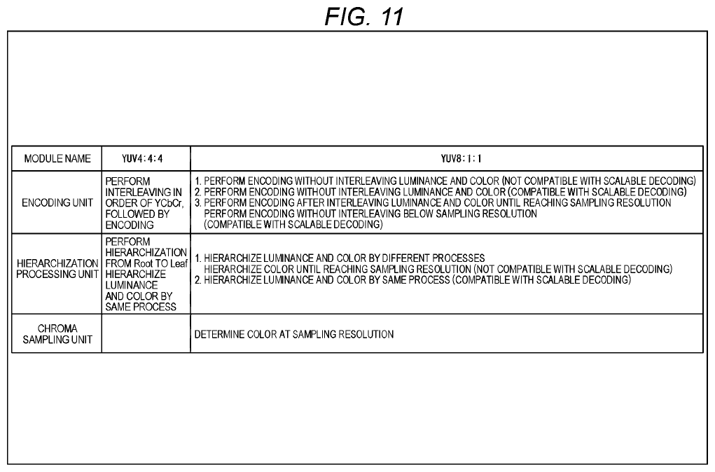

The encoding unit 112, the hierarchization processing unit 111, and the chroma sampling unit 104 described above are further described below with reference to a table shown in FIG. 11.

<Chroma Sampling Unit>

In the case of the encoding method disclosed in Non-Patent Document 1, or when the number of pieces of information regarding luminance and the number of pieces of information regarding color are the same (when YUV 4:4:4 is adopted as the color space), downsampling of the information regarding color is not performed.

On the other hand, the chroma sampling unit 104 determines the color of each point at the sampling resolution, to downsample the information regarding color. By this process, the number of pieces of information regarding color can be reduced.

<Hierarchization Processing Unit>

In the case of the encoding method disclosed in Non-Patent Document 1, or when the number of pieces of information regarding luminance and the number of pieces of information regarding color are the same (when YUV 4:4:4 is adopted as the color space), the information regarding luminance and the information regarding color are hierarchized from the highest hierarchical level (Root) to the lowest hierarchical level (Leaf) through the same process. Accordingly, the hierarchized information about luminance and the hierarchized information about color have the same hierarchical structures.

On the other hand, in the case of the encoding device 100 of this embodiment, the number of pieces of information regarding luminance and the number of pieces of information regarding color differ from each other, because of the downsampling performed by the chroma sampling unit 104. Therefore, the hierarchization processing unit 111 hierarchizes the information regarding luminance and the information regarding color through separate processes. Accordingly, the hierarchized information about luminance and the hierarchized information about color have different hierarchical structures from each other.

<Encoding Unit>

In the case of the encoding method disclosed in Non-Patent Document 1, or when the number of pieces of information regarding luminance and the number of pieces of information regarding color are the same (when YUV 4:4:4 is adopted as the color space), the Y, Cb, and Cr data is interleaved in this order, and lossless encoding is performed on the information regarding luminance and the information regarding color.

On the other hand, in the case of the encoding device 100 of this embodiment, the information regarding luminance and the information regarding color are made to have different hierarchical structures from each other by the hierarchization performed by the hierarchization processing unit 111. Therefore, the encoding unit 112 performs lossless encoding on both the information regarding luminance and the information regarding color, without interleaving. Thus, encoded data of the information regarding luminance and encoded data of the information regarding color are generated.

<Flow in an Encoding Process>

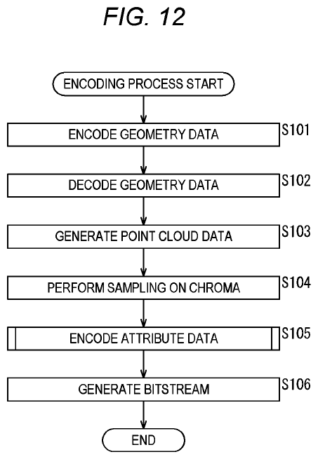

As an example process to be performed by the encoding device 100, an example flow in an encoding process for encoding point cloud data is now described with reference to a flowchart in FIG. 12.

In step S101, the positional information encoding unit 101 of the encoding device 100 encodes the geometry data of point cloud data supplied to the encoding device 100, and generates encoded data of the geometry data.

In step S102, the positional information decoding unit 102 decodes the encoded data of the geometry data generated in step S101, to generate geometry data (a decoding result).

In step S103, the point cloud generation unit 103 performs a recoloring process, to generate point cloud data. That is, the point cloud generation unit 103 generates point cloud data by matching the attribute data of the point cloud data supplied to the encoding device 100 with the geometry data (the decoding result) generated in step S102.

In step S104, the chroma sampling unit 104 downsamples the information regarding color included in the attribute data of the point cloud data generated in step S103. By this process, the information regarding color is associated with the level that is one hierarchical level higher than the lowest hierarchical level in the geometry data. That is, the number of pieces of information about color decreases.

In step S105, the attribute information encoding unit 105 performs an attribute information encoding process, encodes the attribute data in which the number of pieces of information regarding color is reduced by the process in step S104, and generates encoded data of the attribute data. This attribute information encoding process will be described later.

In step S106, the bitstream generation unit 106 generates and outputs a bitstream containing the encoded data of the geometry data generated in step S101 and the encoded data of the attribute data generated in step S105.

When the bitstream generation unit 106 outputs the generated bitstream to the outside of the encoding device 100, the encoding process comes to an end.

<Flow in an Attribute Information Encoding Process>

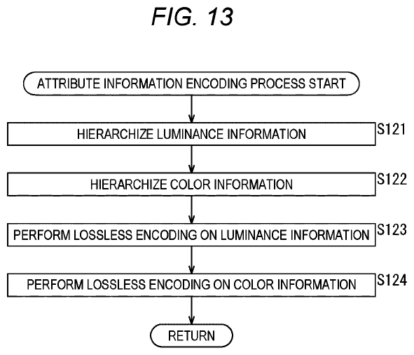

Next, an example flow in the attribute information encoding process to be performed in step S105 in FIG. 12 is described, with reference to a flowchart shown in FIG. 13.

In step S121, the hierarchization processing unit 111 (the luminance hierarchization processing unit 121) hierarchizes the information regarding luminance (also referred to as the luminance information) included in the attribute data.

In step S122, the hierarchization processing unit 111 (the color hierarchization processing unit 122) hierarchizes the information regarding color (also referred to as the color information) included in the attribute data. That is, the hierarchization of the information regarding color and the hierarchization of the information regarding luminance are performed through separate processes.

In step S123, the encoding unit 112 (the luminance encoding unit 131) performs lossless encoding on the information regarding luminance hierarchized in step S121, and generates encoded data of the information regarding luminance.

In step S124, the encoding unit 112 (the color encoding unit 132) performs lossless encoding on the information regarding color hierarchized in step S122, and generates encoded data of the information regarding color. That is, the information regarding luminance and the information regarding color are not interleaved but are subjected to lossless encoding.

When the process in step S124 is completed, the attribute information encoding process comes to an end, and the process returns to FIG. 12.

As the respective processes are performed in such a flow, the encoding device 100 can perform encoding, with the number of pieces of information regarding color being smaller than the number of pieces of information regarding luminance. Thus, the decrease in coding efficiency can be reduced. Typically, coding efficiency can be increased.

### 3. Second Embodiment

<Decoding Device>

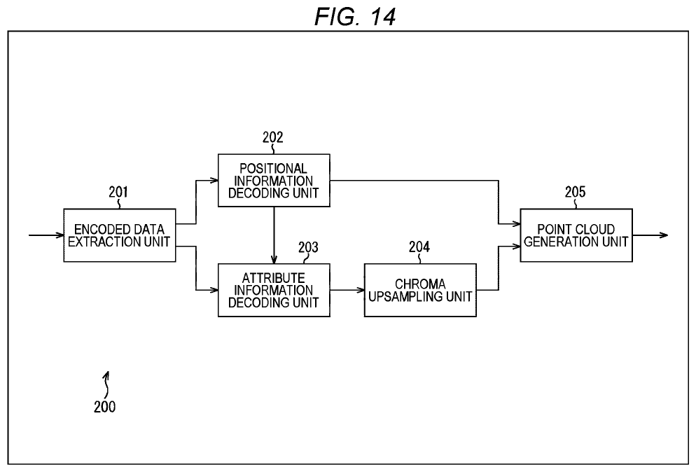

FIG. 14 is a block diagram showing an example configuration of a decoding device as an embodiment of an information processing apparatus to which the present technology is applied. A decoding device 200 shown in FIG. 9 is a device that decodes encoded data of 3D data such as a point cloud. In this decoding, the decoding device 200 decodes encoded data generated by hierarchizing point cloud data using voxels, an octree, or the like, for example. At that time, the decoding device 200 can use YUV 8:1:1 as the color space by appropriately adopting the various methods described above in <1. Color Space Extension in a Point Cloud>.

The decoding device 200 in the case of this embodiment decodes encoded data of point cloud data by a method that is not compatible with scalable decoding, like the encoding device 100 of the first embodiment.

Note that FIG. 14 shows the principal components and aspects such as processing units and the data flow, but does not necessarily show every aspect. That is, in the decoding device 200, there may be a processing unit that is not shown as a block in FIG. 14, or there may be processing or a data flow that is not indicated by an arrow or the like in FIG. 14. This also applies to the other drawings for explaining the processing units and the like in the decoding device 200.

As shown in FIG. 14, the decoding device 200 includes an encoded data extraction unit 201, a positional information decoding unit 202, an attribute information decoding unit 203, a chroma upsampling unit 204, and a point cloud generation unit 205.

The encoded data extraction unit 201 performs a process related to extraction of encoded data from a bitstream. For example, the encoded data extraction unit 201 can acquire a bitstream to be decoded. The encoded data extraction unit 201 can also extract the encoded data of geometry data included in the acquired bitstream, and supply the extracted encoded data to the positional information decoding unit 202. Further, the encoded data extraction unit 201 can extract the encoded data of attribute data included in the acquired bitstream, and supply the extracted encoded data to the attribute information decoding unit 203.

The positional information decoding unit 202 performs a process related to decoding of encoded data of geometry data. For example, the positional information decoding unit 202 can acquire the encoded data of geometry data supplied from the encoded data extraction unit 201. The positional information decoding unit 202 can also perform lossless decoding and inverse hierarchization on the acquired encoded data of geometry data, to generate (restore) the geometry data. Further, the positional information decoding unit 202 can supply the generated geometry data (the decoding result) to the attribute information decoding unit 203 and the point cloud generation unit 205.

Note that the method for the inverse hierarchization and the lossless decoding to be performed by the positional information decoding unit 202 on the encoded data of the geometry data may be any appropriate method compatible with the method for the hierarchization and the lossless encoding performed by the positional information encoding unit 101 of the encoding device 100 (FIG. 9). For example, processing such as filtering for denoising and inverse quantization may be performed.

The attribute information decoding unit 203 performs a process related to decoding of encoded data of attribute data. For example, the attribute information decoding unit 203 can acquire the encoded data of attribute data supplied from the encoded data extraction unit 201. The attribute information decoding unit 203 can also acquire the geometry data (the decoding result) supplied from the positional information decoding unit 202. Further, using the acquired geometry data (the decoding result), the attribute information decoding unit 203 can perform lossless decoding and inverse hierarchization on the acquired encoded data of attribute data, to generate the attribute data. The attribute information decoding unit 203 can also supply the generated attribute data to the chroma upsampling unit 204.

In doing so, the attribute information decoding unit 203 can decode the encoded data of attribute data by appropriately adopting each method described above in <1. Color Space Extension in a Point Cloud> and adopting YUV (YCbCr) 8:1:1.

Note that, as described above in the first embodiment, both the information regarding luminance and the information regarding color are encoded. Therefore, the attribute information decoding unit 203 performs lossless decoding and then inverse hierarchization on both the encoded data of the information regarding luminance and the encoded data of the information regarding color.

The lossless decoding method at that time may be any appropriate method compatible with the lossless encoding performed by the attribute information encoding unit 105 (FIG. 9). For example, processing such as filtering for noise reduction (denoising) and inverse quantization may be performed. Also, the inverse hierarchization method may be any appropriate method compatible with the hierarchization performed by the attribute information encoding unit 105 (FIG. 9).

In the attribute data output by the attribute information decoding unit 203, the number of pieces of information regarding luminance and the number of pieces of information regarding color differ from each other. More specifically, the number of points corresponding to the information regarding color is smaller than the number of points corresponding to the information regarding luminance. More specifically, the number of pieces of information regarding luminance corresponds to the number of leaf nodes in the hierarchical structure of the geometry data, which is the number of points with the highest resolution. On the other hand, the number of pieces of information regarding color corresponds to the number of nodes at the level that is one hierarchical level higher than the lowest hierarchical level in the hierarchical structure of the geometry data, which is the number of points with resolution that is lower than the highest resolution by one hierarchical level.

Therefore, the chroma upsampling unit 204 performs a process related to upsampling of information regarding color. For example, the chroma upsampling unit 204 can acquire the point cloud data supplied from the attribute information decoding unit 203. The chroma upsampling unit 204 can also upsample the information regarding the color of the point cloud data, to associate the data with the lowest hierarchical level in the geometry data. Further, the chroma upsampling unit 204 can supply the attribute data generated by upsampling the information regarding the color to the point cloud generation unit 205.

Note that, in this upsampling, the chroma upsampling unit 204 can appropriately adopt each method explained above in <Upsampling> and others. For example, the chroma upsampling unit 204 can upsample the information regarding color, to generate the information regarding the color of a point corresponding to the lowest hierarchical level in the geometry data. By this upsampling, the number of pieces of information regarding luminance and the number of pieces of information regarding color included in the attribute data become the same.

The point cloud generation unit 205 performs a process related to generation of point cloud data. For example, the point cloud generation unit 205 can acquire the geometry data supplied from the positional information decoding unit 202. The point cloud generation unit 205 can also acquire the attribute data supplied from the chroma upsampling unit 204. Further, the point cloud generation unit 205 can generate point cloud data, using the acquired geometry data and attribute data. The point cloud generation unit 205 can also output the generated point cloud data to the outside of the decoding device 200.

With such a configuration, the decoding device 200 can correctly decode encoded data that has been generated with the number of pieces of information regarding color being smaller than the number of pieces of information regarding luminance. The decoding device 200 can also upsample the information regarding color so that the number of pieces of information regarding luminance and the number of pieces of information regarding color become the same. Thus, the decoding device 200 can reduce the decrease in coding efficiency. Typically, coding efficiency can be increased.

Note that each of these processing units (from the encoded data extraction unit 201 to the point cloud generation unit 205) of the decoding device 200 has any appropriate configuration. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Attribute Information Decoding Unit>

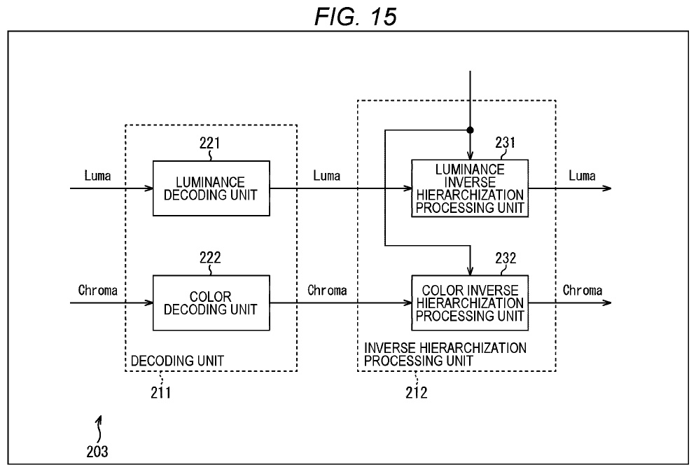

FIG. 15 is a block diagram showing a typical example configuration of the attribute information decoding unit 203 (FIG. 14). As shown in FIG. 15, the attribute information decoding unit 203 includes a decoding unit 211 and an inverse hierarchization processing unit 212.

The decoding unit 211 performs a process related to decoding of encoded data of attribute data. For example, the decoding unit 211 can acquire the encoded data of attribute data supplied from the encoded data extraction unit 201. The decoding unit 211 can also perform lossless decoding on the encoded data of attribute data, and generate (restore) the attribute data. Further, the decoding unit 211 can supply the generated attribute data to the inverse hierarchization processing unit 212.

Meanwhile, in the encoded data of attribute data, the information regarding luminance and the information regarding color are encoded without being interleaved. That is, this encoded data of attribute data includes encoded data of the non-interleaved information regarding luminance and encoded data of the non-interleaved information regarding color. Therefore, the decoding unit 211 adopts one-channel lossless decoding compatible with one-channel lossless encoding, and performs lossless decoding on both the encoded data of the information regarding luminance and the encoded data of the information regarding color.

That is, the decoding unit 211 can decode encoded data of a point cloud expressing a three-dimensional object as a set of points, and generate information regarding the luminance of points corresponding to the lowest hierarchical level in the hierarchized geometry data of the point cloud and information regarding the color of a point corresponding to a predetermined hierarchical level higher than the lowest hierarchical level in the geometry data.

For example, as shown in FIG. 15, the decoding unit 211 includes a luminance decoding unit 221 and a color decoding unit 222.

The luminance decoding unit 221 performs a process related to one-channel lossless decoding of encoded data of information regarding luminance. For example, the luminance decoding unit 221 can acquire the encoded data of information regarding luminance supplied from the encoded data extraction unit 201. The luminance decoding unit 221 can also perform lossless decoding on the encoded data of the information regarding luminance, to generate the information regarding luminance. Further, the luminance decoding unit 221 can supply the generated information regarding luminance to the inverse hierarchization processing unit 212 (the luminance inverse hierarchization processing unit 231).

The color decoding unit 222 performs a process related to one-channel lossless decoding of encoded data of information regarding color. For example, the color decoding unit 222 can acquire the encoded data of information regarding color supplied from the encoded data extraction unit 201. The color decoding unit 222 can also perform lossless decoding on the encoded data of the information regarding color, to generate (restore) the information regarding color. Further, the color decoding unit 222 can supply the generated information regarding color to the chroma upsampling unit.

These decoding methods may be any appropriate methods compatible with the encoding methods adopted by the luminance encoding unit 131 and the color encoding unit 132.

With such a configuration, the decoding unit 211 can adopt one-channel lossless decoding, and perform lossless decoding on both the encoded data of the information regarding luminance and the encoded data of the information regarding color, which have been subjected to lossless encoding without being interleaved. Thus, by this lossless decoding, the decoding unit 211 can generate the information regarding luminance and the information regarding color, which are hierarchized in different hierarchical structures from each other.

The inverse hierarchization processing unit 212 performs a process related to inverse hierarchization of hierarchized attribute data. For example, the inverse hierarchization processing unit 212 can acquire the hierarchized attribute data supplied from the decoding unit 211. The inverse hierarchization processing unit 212 can also acquire the geometry data supplied from the positional information decoding unit 202. Using the geometry data, the inverse hierarchization processing unit 212 can further perform inverse hierarchization on the hierarchized attribute data. Further, the inverse hierarchization processing unit 212 can supply the chroma upsampling unit 204 with the attribute data subjected to the inverse hierarchization.

That is, the inverse hierarchization processing unit 212 can inversely hierarchize, by different processes, the information regarding luminance and the information regarding color generated by the decoding unit 211.

For example, as shown in FIG. 15, the inverse hierarchization processing unit 212 includes a luminance inverse hierarchization processing unit 231 and a color inverse hierarchization processing unit 232.

The luminance inverse hierarchization processing unit 231 performs a process related to inverse hierarchization of information regarding luminance. For example, the luminance inverse hierarchization processing unit 231 can acquire the hierarchized information regarding luminance (Luma) supplied from the decoding unit 211 (the luminance decoding unit 221). The luminance inverse hierarchization processing unit 231 can also acquire the geometry data supplied from the positional information decoding unit 202, for example. Using the geometry data, the luminance inverse hierarchization processing unit 231 can further perform inverse hierarchization on the hierarchized information regarding luminance. Further, the luminance inverse hierarchization processing unit 231 can supply the chroma upsampling unit 204 with the information regarding luminance subjected to the inverse hierarchization.

The method for this inverse hierarchization of the information regarding luminance may be any appropriate method. For example, the luminance inverse hierarchization processing unit 231 may perform the inverse hierarchization by a method compatible with the hierarchization method adopted by the luminance hierarchization processing unit 121.

The color inverse hierarchization processing unit 232 performs a process related to inverse hierarchization of information regarding color. For example, the color inverse hierarchization processing unit 232 can acquire the hierarchized information regarding color (Chroma) supplied from the color decoding unit 222. The color inverse hierarchization processing unit 232 can also acquire the geometry data supplied from the positional information decoding unit 202, for example. Using the geometry data, the color inverse hierarchization processing unit 232 can further perform inverse hierarchization on the hierarchized information regarding color. Further, the color inverse hierarchization processing unit 232 can supply the chroma upsampling unit 204 with the information regarding color subjected to the inverse hierarchization.

The method for this inverse hierarchization of the information regarding color may be any appropriate method. For example, the color inverse hierarchization processing unit 232 may perform the inverse hierarchization by a method compatible with the hierarchization method adopted by the color hierarchization processing unit 122.

With such a configuration, the inverse hierarchization processing unit 212 can inversely hierarchize both the information regarding luminance and the information regarding color through separate processes. Thus, the inverse hierarchization processing unit 212 can inversely hierarchize the information regarding luminance and the information regarding color, which differ from each other in the number of pieces of hierarchized information.

Accordingly, the decoding device 200 can decode encoded data that has been encoded with the number of pieces of information regarding color being smaller than the number of pieces of information regarding luminance, and thus, can reduce the decrease in coding efficiency. Typically, an increase in coding efficiency can be achieved.

Note that these processing units (the decoding unit 211 and the inverse hierarchization processing unit 212) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Explanation of Each Processing Unit>

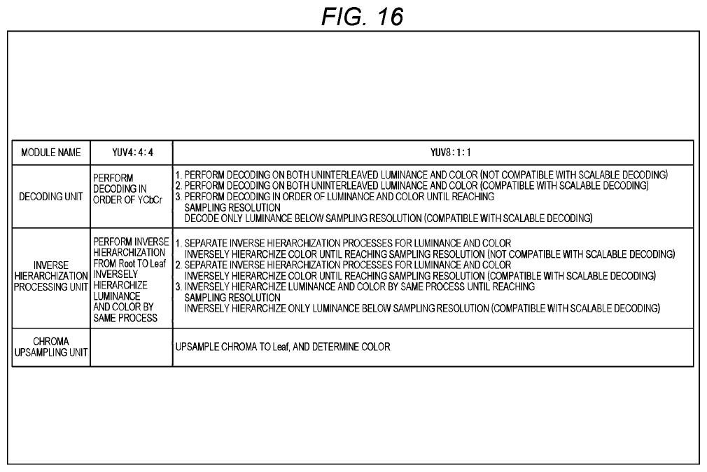

The decoding unit 211, the inverse hierarchization processing unit 212, and the chroma upsampling unit 204 described above are further described below with reference to a table shown in FIG. 16.

<Decoding Unit>

In the case of the decoding method disclosed in Non-Patent Document 1, or when the number of pieces of information regarding luminance and the number of pieces of information regarding color are the same (YUV 4:4:4 is adopted as the color space), the information regarding luminance and the information regarding color have the Y, Cb, and Cr data interleaved in this order, and have been subjected to lossless encoding. Therefore, the encoded data of the information regarding luminance and the encoded data of the information regarding color are decoded in the order of Y, Cb, and Cr.

On the other hand, in the case of the decoding device 200 of this embodiment, both the information regarding luminance and the information regarding color have been encoded without being interleaved. Therefore, the decoding unit 211 performs lossless decoding on both the encoded data of the non-interleaved information regarding luminance and the encoded data of the non-interleaved information regarding color. In such a manner, information regarding luminance and information regarding color that have different hierarchical structures from each other are generated.

<Inverse Hierarchization Processing Unit>

In the case of the decoding method disclosed in Non-Patent Document 1, or when the number of pieces of information regarding luminance and the number of pieces of information regarding color are the same (when YUV 4:4:4 is adopted as the color space), the information regarding luminance and the information regarding color are inversely hierarchized from the highest hierarchical level (Root) to the lowest hierarchical level (Leaf) through the same process.

On the other hand, in the case of the decoding device 200 of this embodiment, the hierarchical structures of the information regarding luminance and the information regarding color differ from each other. Therefore, the inverse hierarchization processing unit 212 inversely hierarchizes the information regarding luminance and the information regarding color by separate processes. Through these processes, the information regarding luminance and the information regarding color that differ from each other in the number of pieces of information can be obtained.

<Chroma Upsampling Unit>

In the case of the encoding method disclosed in Non-Patent Document 1, or when the number of pieces of information regarding luminance and the number of pieces of information regarding color are the same (when YUV 4:4:4 is adopted as the color space), upsampling of the information regarding color is not performed.

On the other hand, the chroma upsampling unit 204 determines the color of each point at the leaf resolution, which is the highest resolution, to upsample the information regarding color. By this process, the number of pieces of the information regarding color can be made the same as that of the information regarding luminance.

<Flow in a Decoding Process>

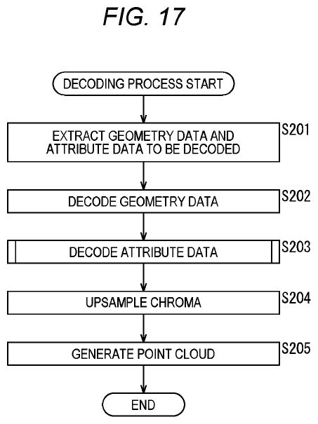

As an example process to be performed by the decoding device 200, an example flow in a decoding process for decoding encoded data of point cloud data is now described with reference to a flowchart in FIG. 17.

In step S201, the encoded data extraction unit 201 of the decoding device 200 extracts, from a bitstream, the geometry data and the attribute data to be decoded.

In step S202, the positional information decoding unit 202 decodes the encoded data of the geometry data extracted in step S201, and generates geometry data.

In step S203, the attribute information decoding unit 203 performs an attribute information decoding process to decode the encoded data of the attribute data extracted in step S201, and generates attribute data. This attribute information decoding process will be described later.

In step S204, the chroma upsampling unit 204 upsamples the information regarding color included in the attribute data generated in step S203. By this process, the information regarding color is associated with the lowest hierarchical level in the geometry data. That is, the number of pieces of the information regarding color becomes larger (becomes equal to the number of pieces of the information regarding luminance).

In step S205, the point cloud generation unit 205 generates point cloud data, using the information regarding luminance generated in step S203 and the information regarding color upsampled in step S204.

After the point cloud generation unit 205 outputs the generated point cloud data to the outside of the decoding device 200, the decoding process comes to an end.

<Flow in an Attribute Information Decoding Process>

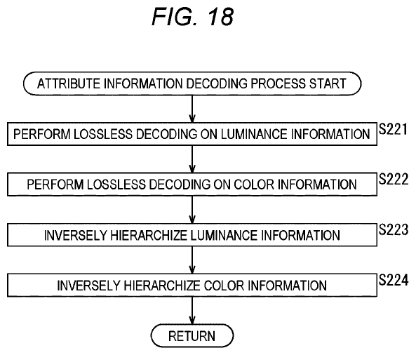

Next, an example flow in the attribute information decoding process to be performed in step S203 in FIG. 17 is described, with reference to a flowchart shown in FIG. 18.

In step S221, the decoding unit 211 (the luminance decoding unit 221) performs lossless decoding on the encoded data of the information regarding luminance (luminance information), and generates the information regarding luminance.

In step S222, the decoding unit 211 (the color decoding unit 222) performs lossless decoding on the encoded data of the information regarding color (color information), and generates the information regarding color.

That is, lossless decoding is performed on both the encoded data of the non-interleaved information regarding luminance and the encoded data of the non-interleaved information regarding color, and thus, both the information regarding luminance and the information regarding color are generated. The information regarding luminance and the information regarding color are both hierarchized, and have different hierarchical structures from each other.

In step S223, the inverse hierarchization processing unit 212 (the luminance inverse hierarchization processing unit 231) inversely hierarchizes the information regarding luminance (hierarchized luminance information) generated in step S221.

In step S224, the inverse hierarchization processing unit 212 (the color inverse hierarchization processing unit 232) inversely hierarchizes the information regarding color (hierarchized color information) generated in step S222. That is, the inverse hierarchization of the information regarding color and the inverse hierarchization of the information regarding luminance are performed through separate processes.

When the process in step S224 is completed, the attribute information decoding process comes to an end, and the process returns to FIG. 17.

By performing the respective processes in the flow as described above, the decoding device 200 can decode encoded data that has been generated with the number of pieces of information regarding color being smaller than the number of pieces of information regarding luminance. Thus, the decrease in coding efficiency can be reduced. Typically, an increase in coding efficiency can be achieved.

### 4. Third Embodiment

<Compatible with Scalable Decoding 1>

Note that point cloud data may be encoded (by a method compatible with scalable decoding) so that scalable decoding can be performed.

<Encoding Device>

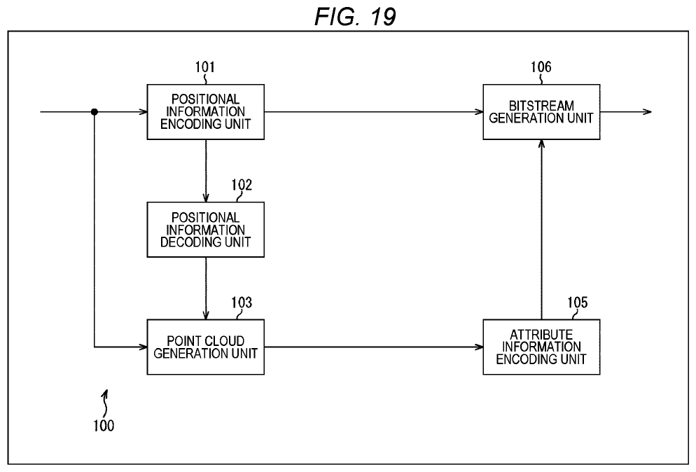

FIG. 19 shows a typical example configuration of an encoding device 100 in that case. As shown in FIG. 19, the encoding device 100 in this case can exclude the chroma sampling unit 104, as compared with the case illustrated in FIG. 9. That is, point cloud data generated through a recoloring process performed by the point cloud generation unit 103 is supplied to the attribute information encoding unit 105.

<Hierarchization Processing Unit and Encoding Unit>

Also, when data is compatible with scalable decoding, the attribute data has a hierarchical structure similar to the hierarchical structure of the geometry data. That is, the geometry data and the attribute data are designed to correspond to each other at any hierarchical level. Accordingly, the information regarding luminance and the information regarding color in this case have hierarchical structures similar to that of the geometry data. In other words, the information regarding luminance and the information regarding color have hierarchical structures similar to each other.

Therefore, in this case, the hierarchization processing unit of the attribute information encoding unit 105 can hierarchize the information regarding luminance and the information regarding color by the same process as indicated as “2.” in the table in FIG. 11.

In the case of this embodiment, however, the encoding unit of the attribute information encoding unit 105 encodes the information regarding luminance and the information regarding color without interleaving, as indicated as “2.” in the table in FIG. 11, as in the case of the first embodiment. The encoding unit then encodes the information regarding luminance from the highest hierarchical level to the lowest hierarchical level, and encodes the information regarding color from the highest hierarchical level to a predetermined hierarchical level (which is one hierarchical level higher than the lowest hierarchical level).

That is, the encoding device 100 in this case reduces the number of hierarchical levels in the information regarding color to be encoded (but not to the lowest hierarchical level), instead of performing downsampling. Accordingly, in the encoding, the number of pieces of information regarding color is smaller than the number of pieces of information regarding luminance. Thus, the encoding device 100 can reduce the decrease in coding efficiency. Typically, coding efficiency can be increased.

<Attribute Information Encoding Unit>

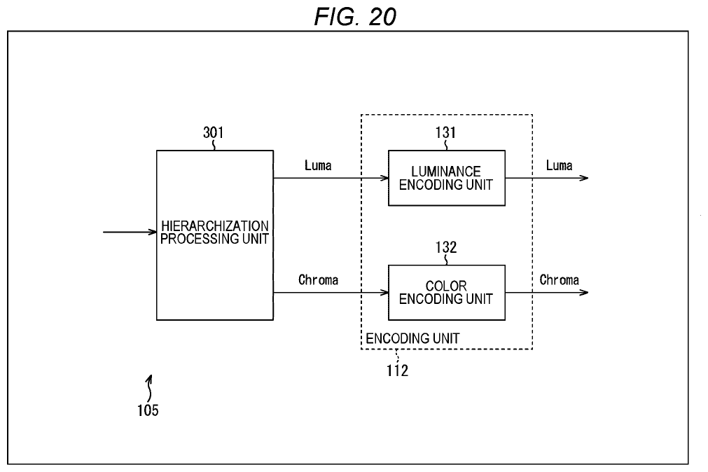

FIG. 20 is a block diagram showing a typical example configuration of the attribute information encoding unit 105 (FIG. 19) in this case. As shown in FIG. 20, the attribute information encoding unit 105 in this case includes a hierarchization processing unit 301 and an encoding unit 112.

The hierarchization processing unit 301 performs a process related to hierarchization of attribute data. For example, the hierarchization processing unit 301 can acquire the point cloud data (attribute data and geometry data (a decoding result)) supplied from the point cloud generation unit 103. Using the geometry data, the hierarchization processing unit 301 can also hierarchize the attribute data by a method that is not compatible with scalable decoding. Further, the hierarchization processing unit 301 can supply the encoding unit 112 with the hierarchized attribute data (the information regarding luminance and the information regarding color).

In this hierarchization, the hierarchization processing unit 301 hierarchizes the information regarding luminance and the information regarding color included in the attribute data through the same process, as described above. The method for hierarchizing this attribute data may be any appropriate method. For example, the hierarchization processing unit 301 may hierarchize the attribute data by RAHT, Lifting, or the like, using the geometry data (decoding result).

The hierarchization processing unit 301 supplies the hierarchized information regarding luminance to the luminance encoding unit 131 of the encoding unit 112. The hierarchization processing unit 301 also supplies the hierarchized information regarding color to the color encoding unit 132 of the encoding unit 112. As in the case of the first embodiment, the encoding unit 112 uses the luminance encoding unit 131 and the color encoding unit 132 to encode the information regarding luminance and the information regarding color, respectively, without interleaving.

By encoding the attribute data in such a manner, the encoding device 100 can encode the point cloud data by a method compatible with scalable decoding, and encode the point cloud data with the number of pieces of information regarding color being smaller than the number of pieces of information regarding luminance. Thus, the decrease in coding efficiency can be reduced. Typically, coding efficiency can be increased.

Note that these processing units (the hierarchization processing unit 301 and the encoding unit 112) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in an Encoding Process>

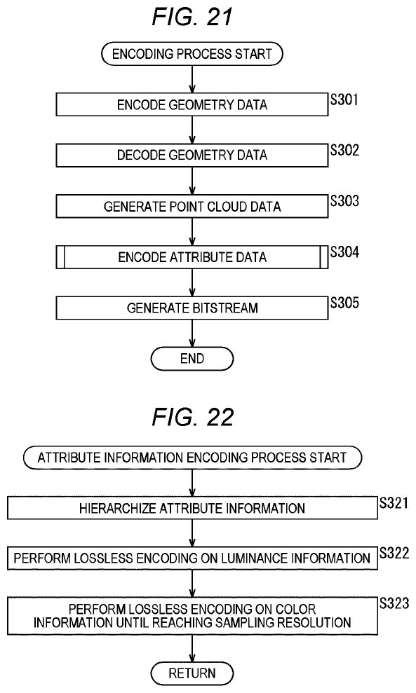

Referring now to a flowchart shown in FIG. 21, an example flow in an encoding process in this case is described. In this case, the respective processes in steps S301 to S305 are performed basically in a manner similar to the respective processes in steps S101 to S103, S105, and S106 in FIG. 12.

<Flow in an Attribute Information Encoding Process>

However, the attribute information encoding process to be performed in step S304 is performed in the flow described below. Referring now to a flowchart in FIG. 22, an example flow in the attribute information encoding process in this case is described.

In step S321, the hierarchization processing unit 301 hierarchizes the attribute data (the information regarding luminance and the information regarding color) by the same process.

In step S322, the encoding unit 112 (the luminance encoding unit 131) performs lossless encoding on all the hierarchical levels (from the highest hierarchical level to the lowest hierarchical level) in the information regarding luminance hierarchized in step S321, and generates encoded data of the information regarding luminance.

In step S323, the encoding unit 112 (the color encoding unit 132) performs lossless encoding on the hierarchical levels from the highest hierarchical level to the hierarchical level of the sampling resolution (one hierarchical level higher than the lowest hierarchical level, for example) in the information regarding color hierarchized in step S321, and generates encoded data of the information regarding color. That is, the information regarding luminance and the information regarding color are not interleaved but are subjected to lossless encoding. In addition to that, the information regarding color is encoded, with the number of its hierarchical levels being made smaller than the number of hierarchical levels in the information regarding luminance.

When the process in step S323 is completed, the attribute information encoding process comes to an end, and the process returns to FIG. 21.

By performing the respective processes in the flow described above, the encoding device 100 can encode the point cloud data by a method compatible with scalable decoding, and encode the point cloud data with the number of pieces of information regarding color being smaller than the number of pieces of information regarding luminance. Thus, the decrease in coding efficiency can be reduced. Typically, coding efficiency can be increased.

<Decoding>

Note that the encoded data generated in such a manner can be decoded by the decoding device 200 described above in the second embodiment. However, the encoded data is compatible with scalable decoding in this case. Therefore, to obtain point cloud data of intermediate resolution (a higher hierarchical level than the lowest hierarchical level), it is only required to decode the geometry data and the attribute data from the highest hierarchical level to the hierarchical level of the intermediate resolution. To obtain point cloud data of the highest resolution (the lowest hierarchical level), on the other hand, it is only required to decode all the geometry data and the attribute data, and upsample the information regarding color up to the highest resolution.

### 5. Fourth Embodiment

<Compatible with Scalable Decoding 2>

Further, when point cloud data is encoded by a method compatible with scalable decoding as in the case of the third embodiment, the information regarding luminance and the information regarding color may be interleaved and be then encoded. However, being different in the number of hierarchical levels from each other, the information regarding luminance and the information regarding color are interleaved and are then encoded within the hierarchical range in which both exist. As for the hierarchical level(s) at which only the information regarding luminance exists (or the hierarchical level(s) at which the information regarding color does not exist), only the information regarding luminance is encoded.

<Hierarchization Processing Unit and Encoding Unit>

That is, in this case, the hierarchization processing unit of the attribute information encoding unit 105 can hierarchize the information regarding luminance and the information regarding color by the same process as indicated as “2.” in the table in FIG. 11 (as in the third embodiment).

However, in the case of this embodiment, the encoding unit of the attribute information encoding unit 105 performs encoding as indicated as “3.” in the table in FIG. 11. Specifically, at the hierarchical levels from the highest hierarchical level to the hierarchical level of the sampling resolution (which is a predetermined hierarchical level (one hierarchical level higher than the lowest hierarchical level, for example)), there exist the information regarding luminance and the information regarding color that have hierarchical structures similar to each other. Therefore, the encoding unit interleaves and then encodes the information regarding luminance and the information regarding color within this hierarchical range. That is, the encoding unit adopts three-channel lossless encoding in the lossless encoding of this hierarchical range. Thus, coding efficiency can be increased.

At a lower hierarchical level (the lowest hierarchical level, for example) than the hierarchical level of the sampling resolution, there exists only the information regarding luminance (the information regarding color does not exist). Therefore, the encoding unit encodes only the information regarding luminance. That is, the encoding unit adopts one-channel lossless encoding in the lossless encoding of this hierarchical range.

The encoding device 100 in this case also reduces the number of hierarchical levels in the information regarding color to be encoded, instead of performing downsampling, as in the third embodiment. Accordingly, in the encoding, the number of pieces of information regarding color is smaller than the number of pieces of information regarding luminance. Thus, the encoding device 100 can reduce the decrease in coding efficiency. Typically, coding efficiency can be increased.

<Attribute Information Encoding Unit>

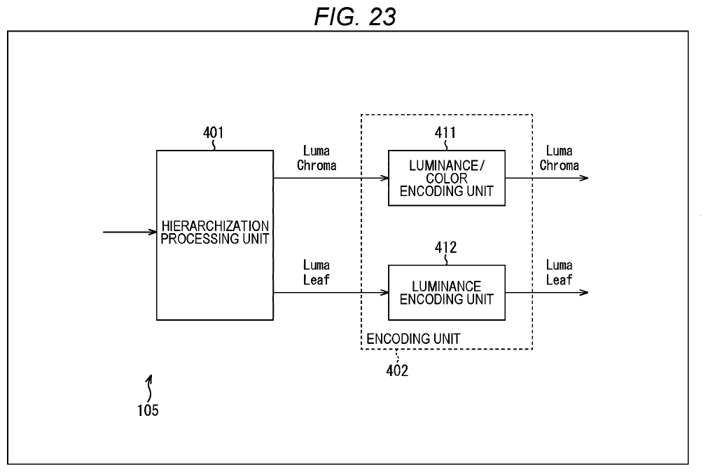

FIG. 23 is a block diagram showing a typical example configuration of the attribute information encoding unit 105 (FIG. 19) in this case. As shown in FIG. 23, the attribute information encoding unit 105 in this case includes a hierarchization processing unit 401 and an encoding unit 402.

The hierarchization processing unit 401 performs a process related to hierarchization of attribute data. For example, the hierarchization processing unit 401 can acquire the point cloud data (attribute data and geometry data (a decoding result)) supplied from the point cloud generation unit 103. Using the geometry data, the hierarchization processing unit 401 can also hierarchize the attribute data by a method that is not compatible with scalable decoding. Further, the hierarchization processing unit 401 can supply the encoding unit 402 with the hierarchized attribute data (the information regarding luminance and the information regarding color).

In this hierarchization, the hierarchization processing unit 401 hierarchizes the information regarding luminance and the information regarding color included in the attribute data through the same process, as in the case of the third embodiment.

However, the hierarchization processing unit 401 supplies the luminance/color encoding unit 411 of the encoding unit 402 with the hierarchized information regarding luminance and the hierarchized information regarding color from the highest hierarchical level to the hierarchical level of the sampling resolution. This hierarchical range of the information regarding color is all the hierarchical levels, but the information regarding luminance also exists at the hierarchical level(s) lower than the hierarchical level of the sampling resolution. Therefore, the hierarchization processing unit 401 supplies the luminance encoding unit 412 of the encoding unit 402 with the remaining information regarding luminance, which is the information regarding the luminance of the lower hierarchical level(s) than the hierarchical level of the sampling resolution.

Like the encoding unit 112, the encoding unit 402 performs a process related to encoding of attribute data. For example, the encoding unit 402 can acquire the hierarchized attribute data supplied from the hierarchization processing unit 111. The encoding unit 402 can also perform lossless encoding on the attribute data, and generate encoded data of the attribute data. Further, the encoding unit 402 can supply the generated encoded data of the attribute data to the bitstream generation unit 106.

However, the encoding unit 402 adopts three-channel lossless encoding in this lossless encoding of the attribute data, and performs interleaving and lossless encoding on the information regarding luminance and the information regarding color from the highest hierarchical level to the hierarchical level of the sampling resolution. The encoding unit 402 also adopts one-channel lossless encoding, and performs lossless encoding on the information regarding luminance at the lower hierarchical level(s) than the hierarchical level of the sampling resolution.

For example, as shown in FIG. 23, the encoding unit 402 includes a luminance/color encoding unit 411 and a luminance encoding unit 412.

The luminance/color encoding unit 411 performs a process related to three-channel lossless encoding of information regarding luminance and information regarding color from the highest hierarchical level to the hierarchical level of the sampling resolution. For example, the luminance/color encoding unit 411 can acquire the information regarding luminance and the information regarding color from the highest hierarchical level to the hierarchical level of the sampling resolution, the information being supplied from the hierarchization processing unit 401. The luminance/color encoding unit 411 can also perform interleaving and lossless encoding on the information regarding luminance and the information regarding color from the highest hierarchical level to the hierarchical level of the sampling resolution, and generate encoded data of the information. Further, the luminance/color encoding unit 411 can supply the generated encoded data of the information regarding luminance and the information regarding color to the bitstream generation unit 106.

The luminance encoding unit 412 performs a process related to one-channel lossless encoding of the information regarding luminance of the lower hierarchical level(s) than the hierarchical level of the sampling resolution. For example, the luminance encoding unit 412 can acquire the information regarding luminance of the lower hierarchical level(s) than the hierarchical level of the sampling resolution, the information being supplied from the hierarchization processing unit 401. The luminance encoding unit 412 can also perform lossless encoding on the information regarding luminance of the lower hierarchical level(s) than the hierarchical level of the sampling resolution, to generate encoded data of the information regarding luminance. Further, the luminance encoding unit 412 can supply the generated encoded data of the information regarding luminance to the bitstream generation unit 106.

By encoding the attribute data in such a manner, the encoding device 100 can encode the point cloud data by a method compatible with scalable decoding, and encode the point cloud data with the number of pieces of information regarding color being smaller than the number of pieces of information regarding luminance. Thus, the decrease in coding efficiency can be reduced. Typically, coding efficiency can be increased.

Note that these processing units (the hierarchization processing unit 401 and the encoding unit 402) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in an Encoding Process>

An encoding process in this case is performed in a flow basically similar to the encoding process in the case of the third embodiment described above with reference to the flowchart in FIG. 21.

<Flow in an Attribute Information Encoding Process>

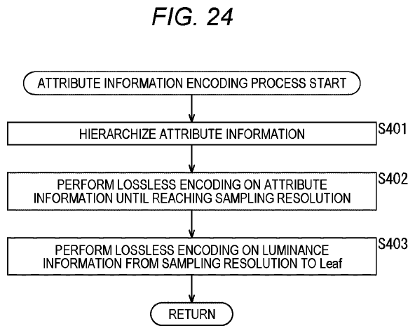

However, the attribute information encoding process to be performed in step S304 is performed in the flow described below. Referring now to a flowchart in FIG. 24, an example flow in the attribute information encoding process in this case is described.

In step S401, the hierarchization processing unit 401 hierarchizes the attribute data (the information regarding luminance and the information regarding color) by the same process.

In step S402, the encoding unit 402 (the luminance/color encoding unit 411) performs lossless encoding on the information regarding luminance and the information regarding color hierarchized in step S401 from the highest hierarchical level to the hierarchical level of the sampling resolution, and generates encoded data of the information.

In step S403, the encoding unit 402 (the luminance encoding unit 412) performs lossless encoding on the information regarding luminance hierarchized in step S401 at the lower hierarchical level(s) than the hierarchical level of the sampling resolution, and generates encoded data of the information.

When the process in step S323 is completed, the attribute information encoding process comes to an end, and the process returns to FIG. 21.

By performing the respective processes in the flow described above, the encoding device 100 can encode the point cloud data by a method compatible with scalable decoding, and encode the point cloud data with the number of pieces of information regarding color being smaller than the number of pieces of information regarding luminance. Thus, the decrease in coding efficiency can be reduced. Typically, coding efficiency can be increased.

<Attribute Information Decoding Unit>

Note that the encoded data generated in such a manner can be decoded by the decoding device 200 described above in the second embodiment. However, the encoded data is compatible with scalable decoding in this case. Therefore, to obtain point cloud data of intermediate resolution (a higher hierarchical level than the lowest hierarchical level), it is only required to decode the geometry data and the attribute data from the highest hierarchical level to the hierarchical level of the intermediate resolution. To obtain point cloud data of the highest resolution (the lowest hierarchical level), on the other hand, it is only required to decode all the geometry data and the attribute data, and upsample the information regarding color up to the highest resolution.

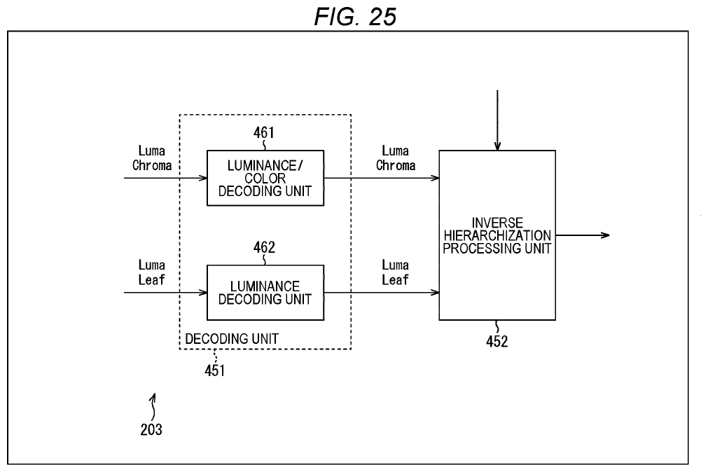

FIG. 25 is a block diagram showing a typical example configuration of the attribute information decoding unit 203 in this case. As shown in FIG. 25, the attribute information decoding unit 203 in this case includes a decoding unit 451 and an inverse hierarchization processing unit 452.

The decoding unit 451 performs a process related to decoding of encoded data of attribute data. For example, the decoding unit 451 can acquire the encoded data of attribute data supplied from the encoded data extraction unit 201. The decoding unit 451 can also perform lossless decoding on the encoded data of attribute data, and generate (restore) the attribute data. Further, the decoding unit 451 can supply the generated attribute data to the inverse hierarchization processing unit 452.

The decoding unit 451 can decode the encoded data of the information regarding the luminance of a point and the information regarding the color of a point corresponding to a predetermined hierarchical level in the geometry data that has been interleaved and encoded, and the encoded data of the information regarding the luminance of points corresponding to the lowest hierarchical level in the geometry data.

For example, as shown in FIG. 25, the decoding unit 451 includes a luminance/color decoding unit 461 and a luminance decoding unit 462.

The luminance/color decoding unit 461 performs a process related to decoding of encoded data of information regarding luminance and information regarding color. For example, the luminance/color decoding unit 461 can acquire the encoded data of the information regarding luminance and the information regarding color from the highest hierarchical level to the hierarchical level of the sampling resolution, the encoded data being supplied from the encoded data extraction unit 201. The luminance/color decoding unit 461 can also perform lossless decoding on the encoded data, and generate (restore) the information regarding luminance and the information regarding color from the highest hierarchical level to the hierarchical level of the sampling resolution. Further, the luminance/color decoding unit 461 can supply the generated information regarding luminance and information regarding color to the inverse hierarchization processing unit 452.

The luminance decoding unit 462 performs a process related to decoding of encoded data of information regarding luminance. For example, the luminance decoding unit 462 can acquire the encoded data of the information regarding luminance of the lower hierarchical level(s) than the sampling resolution, the encoded data being supplied from the encoded data extraction unit 201. The luminance decoding unit 462 can also perform lossless decoding on the encoded data, and generate (restore) the information regarding luminance of the lower hierarchical level(s) than the sampling resolution. Further, the luminance decoding unit 462 can supply the generated information regarding luminance to the inverse hierarchization processing unit 452.

The inverse hierarchization processing unit 452 performs a process related to inverse hierarchization of hierarchized attribute data. For example, the inverse hierarchization processing unit 452 can acquire the information regarding luminance and the information regarding color from the highest hierarchical level to the hierarchical level of the sampling resolution, the information being supplied from the luminance/color decoding unit 461. The inverse hierarchization processing unit 452 can also acquire the information regarding luminance of the lower hierarchical level(s) than the sampling resolution, the information being supplied from the luminance decoding unit 462. Further, the inverse hierarchization processing unit 452 can acquire the geometry data supplied from the positional information decoding unit 202. Using the geometry data, the inverse hierarchization processing unit 452 can also perform inverse hierarchization on the hierarchized information regarding luminance and the hierarchized information regarding color. Further, the inverse hierarchization processing unit 452 can supply the chroma upsampling unit 204 with the information regarding luminance and the information regarding color subjected to the inverse hierarchization.

That is, the inverse hierarchization processing unit 452 can inversely hierarchize, through the same process, the information regarding luminance and the information regarding color generated by the decoding unit 451, and further inversely hierarchize the information regarding the luminance of points corresponding to the lowest hierarchical level in the geometry data, the information being generated by the decoding unit 451.

Accordingly, the decoding device 200 can decode encoded data that has been encoded with the number of pieces of information regarding color being smaller than the number of pieces of information regarding luminance, and thus, can reduce the decrease in coding efficiency. Typically, an increase in coding efficiency can be achieved.

Note that these processing units (the decoding unit 451 and the inverse hierarchization processing unit 452) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<Flow in an Attribute Information Decoding Process>

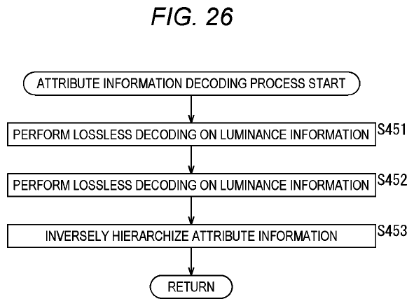

A decoding process in this case is performed in a flow basically similar to the decoding process in the case of the second embodiment described above with reference to the flowchart in FIG. 17. However, the attribute information decoding process to be performed in step S203 is performed in the flow described below. Referring now to a flowchart in FIG. 26, an example flow in the attribute information decoding process in this case is described.

In step S451, the decoding unit 451 (the luminance/color decoding unit 461) performs lossless decoding on the encoded data of the information regarding luminance and the information regarding color from the highest hierarchical level to the hierarchical level of the sampling resolution, and generates the information regarding luminance and the information regarding color.

That is, lossless decoding is performed on the encoded data of the interleaved and encoded information regarding luminance and the encoded data of the interleaved and encoded information regarding color, and thus, the information regarding luminance and the information regarding color are generated. The information regarding luminance and the information regarding color have been hierarchized through the same process, and have the same hierarchical structures.

In step S452, the decoding unit 451 (the luminance decoding unit 462) performs lossless decoding on the encoded data of the information regarding luminance of the lower hierarchical level(s) than the sampling resolution, and generates the information regarding luminance.

That is, lossless decoding is performed on the encoded data of the information regarding luminance of the remaining lower hierarchical level(s). In combination with the process in step S451, the information regarding luminance of all the hierarchical levels is obtained.

In step S453, the inverse hierarchization processing unit 452 inversely hierarchizes the information regarding luminance generated in steps S451 and S452, and the information regarding color generated in step S451.

When the processing in step S453 is completed, the attribute information decoding process comes to an end, and the process returns to FIG. 17.

By performing the respective processes in the flow as described above, the decoding device 200 can decode encoded data that has been generated with the number of pieces of information regarding color being smaller than the number of pieces of information regarding luminance. Thus, the decrease in coding efficiency can be reduced. Typically, an increase in coding efficiency can be achieved.

### 6. Notes

<Partially Scalable Decoding>

Note that, in the third embodiment and the fourth embodiment, cases where the present technology (YUV 8:1:1) is made compatible with scalable decoding have been described. However, this compatibility with scalable decoding may be adopted in part of a hierarchical structure. Only a hierarchical range in a hierarchical structure may be compatible with scalable decoding, and the other hierarchical ranges may not be compatible with scalable decoding.

For example, point cloud data can be encoded by a method not compatible with scalable decoding from the highest hierarchical level to a predetermined hierarchical level in the hierarchical structure of geometry data, and the lower hierarchical level(s) than the predetermined hierarchical level can be encoded by a method compatible with scalable decoding.

The present technology (YUV 8:1:1) described above can also be applied in such a case. For example, a hierarchical range not compatible with scalable decoding may be encoded by the method described in the first embodiment and others (and be decoded by the method described in the second embodiment), and a hierarchical range compatible with scalable decoding may be encoded and decoded by the methods described in the third embodiment and the fourth embodiment.

<Transmission of a Control Flag>

A control flag according to the present technology described in each of the above embodiments may be transmitted from the encoding side to the decoding side. For example, a control flag (enabled flag, for example) for controlling whether or not to allow (or prohibit) adoption of the present technology described above (YUV 8:1:1) may be transmitted. Also, a control flag indicating whether or not to adopt the present technology (YUV 8:1:1) described above may be transmitted. Further, control information regarding the parameters to be used when the present technology (YUV 8:1:1) described above is adopted, such as identification information indicating the upsampling method to be adopted, for example, may be transmitted.

<Computer>

The above described series of processes can be performed by hardware or can be performed by software. When the series of processes are to be performed by software, the program that forms the software is installed into a computer. Here, the computer may be a computer incorporated into special-purpose hardware, or may be a general-purpose personal computer or the like that can execute various kinds of functions when various kinds of programs are installed thereinto, for example.

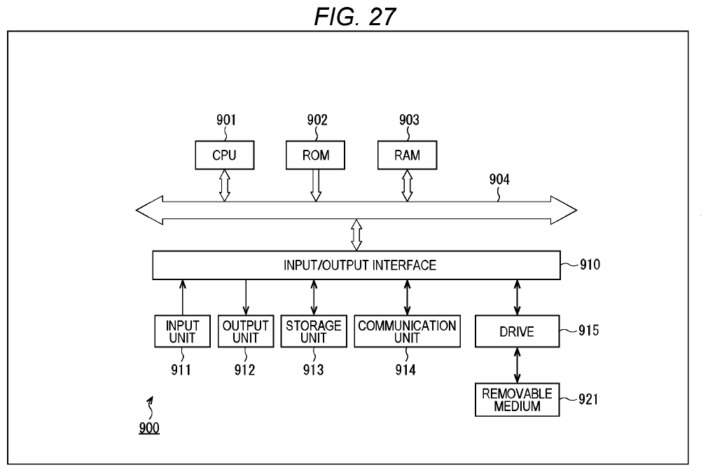

FIG. 27 is a block diagram showing an example configuration of the hardware of a computer that performs the above described series of processes in accordance with a program.

In a computer 900 shown in FIG. 27, a central processing unit (CPU) 901, a read only memory (ROM) 902, and a random access memory (RAM) 903 are connected to one another by a bus 904.

An input/output interface 910 is also connected to the bus 904. An input unit 911, an output unit 912, a storage unit 913, a communication unit 914, and a drive 915 are connected to the input/output interface 910.

The input unit 911 is formed with a keyboard, a mouse, a microphone, a touch panel, an input terminal, and the like, for example. The output unit 912 is formed with a display, a speaker, an output terminal, and the like, for example. The storage unit 913 is formed with a hard disk, a RAM disk, a nonvolatile memory, and the like, for example. The communication unit 914 is formed with a network interface, for example. The drive 915 drives a removable medium 921 such as a magnetic disk, an optical disk, a magnetooptical disk, or a semiconductor memory.

In the computer having the above described configuration, the CPU 901 loads a program stored in the storage unit 913 into the RAM 903 via the input/output interface 910 and the bus 904, for example, and executes the program, so that the above described series of processes is performed. The RAM 903 also stores data necessary for the CPU 901 to perform various processes and the like as necessary.

The program to be executed by the computer may be recorded on the removable medium 921 as a packaged medium or the like to be used, for example. In that case, the program can be installed into the storage unit 913 via the input/output interface 910 when the removable medium 921 is mounted on the drive 915.

Alternatively, this program can be provided via a wired or wireless transmission medium such as a local area network, the Internet, or digital satellite broadcasting. In that case, the program may be received by the communication unit 914, and be installed into the storage unit 913.

Also, this program may be installed beforehand into the ROM 902 or the storage unit 913.

<Targets to which the Present Technology is Applied>

Although cases where the present technology is applied to encoding and decoding of point cloud data have been described so far, the present technology is not limited to those examples, but can be applied to encoding and decoding of 3D data of any standard. That is, various processes such as encoding and decoding processes, and any specifications of various kinds of data such as 3D data and metadata can be adopted, as long as the present technology described above is not contradicted. Also, some of the processes and specifications described above may be omitted, as long as the present technology is not contradicted.

Further, in the above description, the encoding device 100 and the decoding device 200 have been described as example applications of the present technology, but the present technology can be applied to any desired configuration.

For example, the present technology can be applied to various electronic apparatuses, such as transmitters and receivers (television receivers or portable telephone devices, for example) in satellite broadcasting, cable broadcasting such as cable TV, distribution via the Internet, distribution to terminals via cellular communication, or the like, and apparatuses (hard disk recorders or cameras, for example) that record images on media such as optical disks, magnetic disks, and flash memory, and reproduce images from these storage media, for example.

Further, the present technology can also be embodied as a component of an apparatus, such as a processor (a video processor, for example) serving as a system LSI (Large Scale Integration) or the like, a module (a video module, for example) using a plurality of processors or the like, a unit (a video unit, for example) using a plurality of modules or the like, or a set (a video set, for example) having other functions added to units.

Further, the present technology can also be applied to a network system formed with a plurality of devices, for example. For example, the present technology may be embodied as cloud computing that is shared and jointly processed by a plurality of devices via a network. For example, the present technology may be embodied in a cloud service that provides services related to images (video images) to any kinds of terminals such as computers, audio visual (AV) devices, portable information processing terminals, and IoT (Internet of Things) devices.

Note that, in the present specification, a system means an assembly of plurality of components (devices, modules (parts), and the like), and not all the components need to be provided in the same housing. In view of this, plurality of devices that are housed in different housings and are connected to one another via a network form a system, and one device having plurality of modules housed in one housing is also a system.

<Fields and Usage to which the Present Technology can be Applied>

A system, an apparatus, a processing unit, and the like to which the present technology is applied can be used in any appropriate field such as transportation, medical care, crime prevention, agriculture, the livestock industry, mining, beauty care, factories, household appliances, meteorology, or nature observation, for example. The present technology can also be used for any appropriate purpose.

<Other Aspects>

Note that, in this specification, a “flag” is information for identifying a plurality of states, and includes not only information to be used for identifying two states of true (1) or false (0), but also information for identifying three or more states. Therefore, the values this “flag” can have may be the two values of “1” and “0”, for example, or three or more values. That is, this “flag” may be formed with any number of bits, and may be formed with one bit or a plurality of bits. Further, as for identification information (including a flag), not only the identification information but also difference information about the identification information with respect to reference information may be included in a bitstream. Therefore, in this specification, a “flag” and “identification information” include not only the information but also difference information with respect to the reference information.

Further, various kinds of information (such as metadata) regarding encoded data (a bitstream) may be transmitted or recorded in any mode that is associated with the encoded data. Here, the term “to associate” means to enable use of other data (or a link to other data) while data is processed, for example. That is, pieces of data associated with each other may be integrated as one piece of data, or may be regarded as separate pieces of data. For example, information associated with encoded data (an image) may be transmitted through a transmission path different from that for the encoded data (image). Further, information associated with encoded data (an image) may be recorded in a recording medium different from that for the encoded data (image) (or in a different recording area of the same recording medium), for example. Note that this “association” may apply to part of the data, instead of the entire data. For example, an image and the information corresponding to the image may be associated with each other for any appropriate unit, such as for a plurality of frames, each frame, or some portion in each frame.

Note that, in this specification, the terms “to combine”, “to multiplex”, “to add”, “to integrate”, “to include”, “to store”, “to contain”, “to incorporate”, “to insert”, and the like mean combining a plurality of objects into one, such as combining encoded data and metadata into one piece of data, for example, and mean a method of the above described “association”.

Further, embodiments of the present technology are not limited to the above described embodiments, and various modifications may be made to them without departing from the scope of the present technology.

For example, any configuration described above as one device (or one processing unit) may be divided into a plurality of devices (or processing units). Conversely, any configuration described above as a plurality of devices (or processing units) may be combined into one device (or one processing unit). Furthermore, it is of course possible to add a component other than those described above to the configuration of each device (or each processing unit). Further, some components of a device (or processing unit) may be incorporated into the configuration of another device (or processing unit) as long as the configuration and the functions of the entire system remain substantially the same.

Also, the program described above may be executed in any device, for example. In that case, the device is only required to have necessary functions (function blocks and the like) so that necessary information can be obtained.

Also, one device may carry out each step in one flowchart, or a plurality of devices may carry out each step, for example. Further, when one step includes a plurality of processes, the plurality of processes may be performed by one device or may be performed by a plurality of devices. In other words, a plurality of processes included in one step may be performed as processes in a plurality of steps. Conversely, processes described as a plurality of steps may be collectively performed as one step.

Also, a program to be executed by a computer may be a program for performing the processes in the steps according to the program in chronological order in accordance with the sequence described in this specification, or may be a program for performing processes in parallel or performing a process when necessary, such as when there is a call, for example. That is, as long as there are no contradictions, the processes in the respective steps may be performed in a different order from the above described order. Further, the processes in the steps according to this program may be executed in parallel with the processes according to another program, or may be executed in combination with the processes according to another program.

Also, each of the plurality of techniques according to the present technology can be independently implemented, as long as there are no contradictions, for example. It is of course also possible to implement a combination of some of the plurality of techniques according to the present technology. For example, part or all of the present technology described in one of the embodiments may be implemented in combination with part or all of the present technology described in another one of the embodiments. Further, part or all of the present technology described above may be implemented in combination with some other technology not described above.

Note that the present technology can also be embodied in the configurations described below.

(1) An information processing apparatus including

an encoding unit that encodes information regarding luminance of a point corresponding to the lowest hierarchical level in hierarchized geometry data, and information regarding color of a point corresponding to a predetermined hierarchical level higher than the lowest hierarchical level in the geometry data, in a point cloud expressing a three-dimensional object as a set of the points.

(2) The information processing apparatus according to (1), in which

the encoding unit encodes both the information regarding the luminance of the point and the information regarding the color of the point.

(3) The information processing apparatus according to (2), further including

a hierarchization unit that hierarchizes the information regarding the luminance of the point and the information regarding the color of the point by different processes,

in which the encoding unit encodes both the information regarding the luminance of the point, the information being hierarchized by the hierarchization unit, and the information regarding the color of the point, the information being hierarchized by the hierarchization unit.

(4) The information processing apparatus according to (3), further including

a downsampling unit that performs downsampling on the information regarding the color of the point, and generates the information regarding the color of the point corresponding to the predetermined hierarchical level in the geometry data,

in which the hierarchization unit hierarchizes the information regarding the color of the point corresponding to the predetermined hierarchical level in the geometry data by a different process from a process for the information regarding the luminance of the point, the information regarding the color of the point being generated by the downsampling unit.

(5) The information processing apparatus according to (4), in which

the downsampling unit derives the information regarding the color of the point corresponding to the predetermined hierarchical level in the geometry data, using the information regarding the color of the point corresponding to the lowest hierarchical level in the geometry data.

(6) The information processing apparatus according to (5), in which

the downsampling unit derives the information regarding the color of the point corresponding to a voxel by averaging the information regarding the color of the point corresponding to the lowest hierarchical level in the geometry data, the point being located in the voxel corresponding to the predetermined hierarchical level in the geometry data.

(7) The information processing apparatus according to (5), in which

the downsampling unit performs a recoloring process for associating the information regarding the color of the point with the geometry data, to derive the information regarding the color of the point corresponding to the predetermined hierarchical level in the geometry data.

(8) The information processing apparatus according to any one of (2) to (7), further including

a hierarchization unit that hierarchizes the information regarding the luminance of the point and the information regarding the color of the point by the same process,

in which the encoding unit encodes both the information regarding the luminance of the point, the information being hierarchized by the hierarchization unit, and the information regarding the color of the point, the information being hierarchized by the hierarchization unit.

(9) The information processing apparatus according to (1), in which

the encoding unit interleaves and encodes the information regarding the luminance of the point and the information regarding the color of the point corresponding to the predetermined hierarchical level in the geometry data, and encodes the information regarding the luminance of the point corresponding to the lowest hierarchical level in the geometry data.

(10) The information processing apparatus according to (9), further including

a hierarchization unit that hierarchizes the information regarding the luminance of the point and the information regarding the color of the point by the same process,

in which the encoding unit interleaves and encodes the information regarding the luminance of the point and the information regarding the color of the point corresponding to the predetermined hierarchical level in the geometry data, the information being hierarchized by the hierarchization unit, and encodes the information regarding the luminance of the point corresponding to the lowest hierarchical level in the geometry data.

(11) The information processing apparatus according to any one of (1) to (10), in which

the predetermined hierarchical level is a hierarchical level that is one level higher than the lowest hierarchical level.

(12) The information processing apparatus according to any one of (1) to (11), further including

a bitstream generation unit that generates a bitstream including encoded data of the information regarding the luminance of the point and encoded data of the information regarding the color of the point, and encoded data of the geometry data, the encoded data being generated by the encoding unit.

(13) The information processing apparatus according to (12), in which,

in the bitstream, the information regarding the luminance of the point, the information regarding the color of the point, and the geometry data are arranged in the same predetermined order.

(14) The information processing apparatus according to (13), in which

the predetermined order is a Morton order.

(15) An information processing method including

encoding information regarding luminance of a point corresponding to the lowest hierarchical level in hierarchized geometry data, and information regarding color of a point corresponding to a predetermined hierarchical level higher than the lowest hierarchical level in the geometry data, in a point cloud expressing a three-dimensional object as a set of the points.

(16) An information processing apparatus including

a decoding unit that decodes encoded data of a point cloud expressing a three-dimensional object as a set of points, and generates information regarding luminance of the point corresponding to the lowest hierarchical level in hierarchized geometry data of the point cloud, and information regarding color of the point corresponding to a predetermined hierarchical level higher than the lowest hierarchical level in the geometry data.

(17) The information processing apparatus according to (16), in which

the decoding unit decodes encoded data of the information regarding the luminance of the point, and encoded data of the information regarding the color of the point.

(18) The information processing apparatus according to (17), further including

an inverse hierarchization unit that inversely hierarchizes the information regarding the luminance of the point and the information regarding the color of the point by different processes, the information being generated by the decoding unit.

(19) The information processing apparatus according to (18), further including

an upsampling unit that performs upsampling on the information regarding the color of the point, and generates the information regarding the color of the point corresponding to the lowest hierarchical level in the geometry data.

(20) The information processing apparatus according to (19), in which

the upsampling unit derives the information regarding the color of the point corresponding to the lowest hierarchical level in the geometry data, using the information regarding the color of the point corresponding to the predetermined hierarchical level in the geometry data.

(21) The information processing apparatus according to (20), in which

the upsampling unit derives the information regarding the color of the point corresponding to the lowest hierarchical level in the geometry data, by duplicating the information regarding the color of the point corresponding to the predetermined hierarchical level in the geometry data.

(22) The information processing apparatus according to (20), in which

the upsampling unit performs a recoloring process for associating the information regarding the color of the point with the geometry data, to derive the information regarding the color of the point corresponding to the lowest hierarchical level in the geometry data.

(23) The information processing apparatus according to (16), in which

the decoding unit decodes encoded data of the information regarding the luminance of the point and the information regarding the color of the point corresponding to the predetermined hierarchical level in the geometry data, the information being interleaved and encoded, and decodes encoded data of the information regarding the luminance of the point corresponding to the lowest hierarchical level in the geometry data.

(24) The information processing apparatus according to (23), further including

an inverse hierarchization unit that inversely hierarchizes the information regarding the luminance of the point and the information regarding the color of the point corresponding to the predetermined hierarchical level in the geometry data by the same process, the information being generated by the decoding unit, and further inversely hierarchizes the information regarding the luminance of the point corresponding to the lowest hierarchical level in the geometry data, the information being generated by the decoding unit.

(25) The information processing apparatus according to (24), further including

an upsampling unit that performs upsampling on the information regarding the color of the point corresponding to the predetermined hierarchical level in the geometry data, the information being inversely hierarchized by the inverse hierarchization unit, and generates the information regarding the color of the point corresponding to the lowest hierarchical level in the geometry data.

(26) The information processing apparatus according to (25), in which

the upsampling unit derives the information regarding the color of the point corresponding to the lowest hierarchical level in the geometry data, using the information regarding the color of the point corresponding to the predetermined hierarchical level in the geometry data.

(27) The information processing apparatus according to (26), in which

the upsampling unit derives the information regarding the color of the point corresponding to the lowest hierarchical level in the geometry data, by duplicating the information regarding the color of the point corresponding to the predetermined hierarchical level in the geometry data.

(28) The information processing apparatus according to (26), in which

the upsampling unit performs a recoloring process for associating the information regarding the color of the point with the geometry data, to derive the information regarding the color of the point corresponding to the lowest hierarchical level in the geometry data.

(29) The information processing apparatus according to any one of (16) to (28), in which

the predetermined hierarchical level is a hierarchical level that is one level higher than the lowest hierarchical level.

(30) An information processing method including

decoding encoded data of a point cloud expressing a three-dimensional object as a set of points, and generating information regarding luminance of the point corresponding to the lowest hierarchical level in hierarchized geometry data of the point cloud, and information regarding color of the point corresponding to a predetermined hierarchical level higher than the lowest hierarchical level in the geometry data.

### REFERENCE SIGNS LIST

100 Encoding device
101 Positional information encoding unit
102 Positional information decoding unit
103 Point cloud generation unit
104 Chroma sampling unit
105 Attribute information encoding unit
106 Bitstream generation unit
111 Hierarchization processing unit
112 Encoding unit
121 Luminance hierarchization processing unit
122 Color hierarchization processing unit
131 Luminance encoding unit
132 Color encoding unit
200 Decoding device
201 Encoded data extraction unit
202 Positional information decoding unit
203 Attribute information decoding unit
204 Chroma upsampling unit
205 Point cloud generation unit
211 Decoding unit
212 Inverse hierarchization processing unit
221 Luminance decoding unit
222 Color decoding unit
231 Luminance inverse hierarchization processing unit
232 Color inverse hierarchization processing unit
301 Hierarchization processing unit
401 Hierarchization processing unit
402 Encoding unit
411 Luminance/color encoding unit
412 Luminance encoding unit
451 Decoding unit
452 Inverse hierarchization processing unit
461 Luminance/color decoding unit
462 Luminance decoding unit

1. An information processing apparatus comprising
an encoding unit that encodes information regarding luminance of a point corresponding to the lowest hierarchical level in hierarchized geometry data, and information regarding color of a point corresponding to a predetermined hierarchical level higher than the lowest hierarchical level in the geometry data, in a point cloud expressing a three-dimensional object as a set of the points.

2. The information processing apparatus according to claim 1, wherein
the encoding unit encodes both the information regarding the luminance of the point and the information regarding the color of the point.

3. The information processing apparatus according to claim 2, further comprising
a hierarchization unit that hierarchizes the information regarding the luminance of the point and the information regarding the color of the point by different processes,
wherein the encoding unit encodes both the information regarding the luminance of the point, the information being hierarchized by the hierarchization unit, and the information regarding the color of the point, the information being hierarchized by the hierarchization unit.

4. The information processing apparatus according to claim 3, further comprising
a downsampling unit that performs downsampling on the information regarding the color of the point, and generates the information regarding the color of the point corresponding to the predetermined hierarchical level in the geometry data,
wherein the hierarchization unit hierarchizes the information regarding the color of the point corresponding to the predetermined hierarchical level in the geometry data by a different process from a process for the information regarding the luminance of the point, the information regarding the color of the point being generated by the downsampling unit.

5. The information processing apparatus according to claim 4, wherein
the downsampling unit derives the information regarding the color of the point corresponding to the predetermined hierarchical level in the geometry data, using the information regarding the color of the point corresponding to the lowest hierarchical level in the geometry data.

6. The information processing apparatus according to claim 2, further comprising
a hierarchization unit that hierarchizes the information regarding the luminance of the point and the information regarding the color of the point by the same process,
wherein the encoding unit encodes both the information regarding the luminance of the point, the information being hierarchized by the hierarchization unit, and the information regarding the color of the point, the information being hierarchized by the hierarchization unit.

7. The information processing apparatus according to claim 1, wherein
the encoding unit interleaves and encodes the information regarding the luminance of the point and the information regarding the color of the point corresponding to the predetermined hierarchical level in the geometry data, and encodes the information regarding the luminance of the point corresponding to the lowest hierarchical level in the geometry data.

8. The information processing apparatus according to claim 7, further comprising
a hierarchization unit that hierarchizes the information regarding the luminance of the point and the information regarding the color of the point by the same process,
wherein the encoding unit interleaves and encodes the information regarding the luminance of the point and the information regarding the color of the point corresponding to the predetermined hierarchical level in the geometry data, the information being hierarchized by the hierarchization unit, and encodes the information regarding the luminance of the point corresponding to the lowest hierarchical level in the geometry data.

9. The information processing apparatus according to claim 1, wherein
the predetermined hierarchical level is a hierarchical level that is one level higher than the lowest hierarchical level.

10. An information processing method comprising
encoding information regarding luminance of a point corresponding to the lowest hierarchical level in hierarchized geometry data, and information regarding color of a point corresponding to a predetermined hierarchical level higher than the lowest hierarchical level in the geometry data, in a point cloud expressing a three-dimensional object as a set of the points.

11. An information processing apparatus comprising
a decoding unit that decodes encoded data of a point cloud expressing a three-dimensional object as a set of points, and generates information regarding luminance of the point corresponding to the lowest hierarchical level in hierarchized geometry data of the point cloud, and information regarding color of the point corresponding to a predetermined hierarchical level higher than the lowest hierarchical level in the geometry data.

12. The information processing apparatus according to claim 11, wherein
the decoding unit decodes encoded data of the information regarding the luminance of the point, and encoded data of the information regarding the color of the point.

13. The information processing apparatus according to claim 12, further comprising
an inverse hierarchization unit that inversely hierarchizes the information regarding the luminance of the point and the information regarding the color of the point by different processes, the information being generated by the decoding unit.

14. The information processing apparatus according to claim 13, further comprising
an upsampling unit that performs upsampling on the information regarding the color of the point, and generates the information regarding the color of the point corresponding to the lowest hierarchical level in the geometry data.

15. The information processing apparatus according to claim 14, wherein
the upsampling unit derives the information regarding the color of the point corresponding to the lowest hierarchical level in the geometry data, using the information regarding the color of the point corresponding to the predetermined hierarchical level in the geometry data.

16. The information processing apparatus according to claim 11, wherein
the decoding unit decodes encoded data of the information regarding the luminance of the point and the information regarding the color of the point corresponding to the predetermined hierarchical level in the geometry data, the information being interleaved and encoded, and decodes encoded data of the information regarding the luminance of the point corresponding to the lowest hierarchical level in the geometry data.

17. The information processing apparatus according to claim 16, further comprising
an inverse hierarchization unit that inversely hierarchizes the information regarding the luminance of the point and the information regarding the color of the point corresponding to the predetermined hierarchical level in the geometry data by the same process, the information being generated by the decoding unit, and further inversely hierarchizes the information regarding the luminance of the point corresponding to the lowest hierarchical level in the geometry data, the information being generated by the decoding unit.

18. The information processing apparatus according to claim 17, further comprising
an upsampling unit that performs upsampling on the information regarding the color of the point corresponding to the predetermined hierarchical level in the geometry data, the information being inversely hierarchized by the inverse hierarchization unit, and generates the information regarding the color of the point corresponding to the lowest hierarchical level in the geometry data.

19. The information processing apparatus according to claim 11, wherein
the predetermined hierarchical level is a hierarchical level that is one level higher than the lowest hierarchical level.

20. An information processing method comprising
decoding encoded data of a point cloud expressing a three-dimensional object as a set of points, and generating information regarding luminance of the point corresponding to the lowest hierarchical level in hierarchized geometry data of the point cloud, and information regarding color of the point corresponding to a predetermined hierarchical level higher than the lowest hierarchical level in the geometry data.
